(19) United States
(12) Patent Application Publication
(10) Pub. No.: US 2012/0201062 A1
(43) Pub. Date: Aug. 9, 2012

(54) STANDBY POWER CUT-OFF DEVICE AND CONTROL METHOD THEREOF AND POWER SUPPLY

(75) Inventor: Sung-Sub Lee, Anyang-si (KR)

(73) Assignee: Seoby Electronics Co., Ltd., Anyang-si (KR)

(21) Appl. No.: 13/140,913

(22) PCT Filed: Oct. 22, 2010
(86) PCT No.: PCT/KR2010/007258

§ 371 Date: Jun. 20, 2011

(30) Foreign Application Priority Data
Oct. 29, 2009 (KR) 10-2009-0103656
Oct. 14, 2010 (KR) 10-2010-0100446

(51) Int. Cl. H02M 7/04; H04B 10/00; H01H 47/00

(52) U.S. Cl. 363/84; 307/113; 398/115

(57) ABSTRACT

The present invention is related to a standby power cut-off device that cuts off standby power generated from an electrical appliance by learning power on/off control data sent from a remote control, and upon receipt of the power on/off control data of the remote control, simultaneously controls commercial power (main power) supplied to the electrical appliance, and a control method thereof.

The standby power cut-off device includes: a voltage converter for converting commercial power into DC power; a charging/discharging unit for charging the DC power supplied from the voltage converter and supplying the same as operating power; a voltage detector for detecting a charging level of the charging/discharging unit; a receiver for receiving power on/off control data of a remote control; a controller for executing standby power cut-off control of a designated electrical appliance in accordance with the power on/off control data of the remote control; a first switch that is switched on/off under the control of the controller to permit or cut off the commercial power supplied to the electrical appliance; a transmitter for sending the power on control data of the electrical appliance under the control of the controller; and a second switch that is switched on/off under the control of the controller to permit or cut off the commercial power supplied to the voltage converter.

### CROSS-REFERENCE TO RELATED APPLICATION

This application claims priority to and the benefit of Korean Patent Application No. 10-2009-0103656 and 10-2010-0100446 filed in the Korean Intellectual Property Office on Oct. 29, 2009 and Oct. 14, 2010, the entire contents of which are incorporated herein by reference.

### BACKGROUND OF THE INVENTION

(a) Field of the Invention

The present invention relates to a standby power cut-off device and a control method thereof. More particularly, the present invention relates to a standby power cut-off device that cuts off standby power generated from an electrical appliance by learning power on/off control signal sent from a remote control, and upon receipt of the power on/off control signal, a control method for simultaneously controlling commercial power (main power) supplied to the electrical appliance, and a power supply.

(b) Description of the Related Art

In general, to use electrical appliances such as a copier, a video recorder, a dishwasher, a mobile phone charger, a computer, a monitor, a printer, a facsimile machine, a washing machine, an air conditioner, etc., a power socket installed in a wall of a building or a power strip extending from the socket or the like is used for supply of commercial power.

Further, in the installation of the aforementioned electrical appliance, the plug of the electrical appliance coupled to the socket installed in the wall of the building or to the power strip has a structure in which is typically kept connected all the time, so commercial power is always supplied irrespective of whether the electrical appliance is used or not.

As mentioned above, in the case that the plug of the electrical appliance is connected to be always supplied with commercial power, the standby time for a function in a power off state is given more weight than the time for executing the original function of the electrical appliance. This leads to excessive consumption of standby power (vampire power), which plays a very important role in determining the level of energy efficiency of the electrical appliance.

According to the International Energy Agency (IEA), it is estimated that 10 to 15% of power consumption per home in OECD countries is standby power.

It has been released that about 11% to 12% of annual power consumption is standby power in some countries, and this shows that energy waste is excessively high.

To solve such a serious standby power consumption issue, the International Energy Agency made recommendations to the countries of the world to reduce the standby power of all electrical appliances to below 1 watt (W).

Power-saving electrical appliances of various types have been developed and distributed in each participating country to save energy and protect the environment, and the energy efficiency of electrical appliances is multi-graded for the distribution of energy-saving products.

In order to completely cut off the aforementioned standby power consumption in an electrical appliance, a user has to completely cut off commercial power (main power) supplied to the electrical appliance by removing the plug of the electrical appliance connected to a socket or multi-outlet power strip or turn off power switches mounted in respective sockets of the power strip, which is very cumbersome. Due to this, complete cut-off of standby power is not put into wide practical use.

Moreover, constant supply of commercial power (main power) to an electrical appliance via a plug connected to a socket causes deterioration of parts, thus shortening the lifespan of the electrical appliance. In the case of an overcurrent caused by lightning strikes, it is often the case that the overcurrent is directly introduced to the electrical appliance along a power line and damages the electrical appliance.

Further, devices for cutting off standby power if an electrical appliance is identified as powered off by recognizing the power consumption of the electrical appliance have been developed and mounted on electrical appliances. However, these devices are not operable in a power-on operation, so a user has to bear the inconvenience of manipulating a power switch mounted on an electrical appliance.

For example, a wake-up alarm is set in a television, power supply to a timer module of the television is cut off when standby power is cut off so that reserved time data is detected, thereby causing a reservation function not to be executed.

In addition, among home electrical appliances, an electrical appliance to which a remote controller is not applied, e.g., a laundry, a dish-washer, or a microwave has relatively long standby time than used time but a power plug is always connected.

Thus, when the electrical appliance is not being used, approximately 3W of high power is consumed by a power supply even though a power switch is selected to be in the power-off state so that the standby power is always used unless the power plug is disconnected.

Also, there arises the problem that a reservation function included in an electrical appliance cannot be used because standby power cut-off devices provided in various types cut off commercial power (main power) supplied to the electrical appliance.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a standby power cut-off device that can cut off standby power generated from an electrical appliance by learning power on/off control data sent from a remote control, and upon receipt of the power on/off control data of the remote control, simultaneously controls commercial power (main power) supplied to the electrical appliance.

An exemplary embodiment of the present invention provides a standby power cut-off device that is composed of a multi-outlet power strip, and that cuts off standby power generated in the multi-outlet power strip by supplying power to a circuit configured in the multi-outlet power strip by instantaneous charging using a super condenser.

Another exemplary embodiment of the present invention provides a standby power cut-off device that, upon receipt of power off control data of the electrical appliance, cuts off commercial power (main power) supplied to an electrical appliance and a multi-outlet power strip after a predetermined time, and, upon receipt of power-on control data, firstly supplies commercial power (main power) to the electrical appliance and then sends the learned power-on control data to the electrical appliance to perform the power-on operation of the electrical appliance.

Yet another exemplary embodiment of the present invention provides a standby power cut-off device that includes a programming function, and executes the power on/off control and standby power cut-off control of a designated electrical appliance when a programmed time set by a remote control is reached by executing a counter.

Yet another exemplary embodiment of the present invention provides a power supply installed in an electrical appliance to supply a standby power cut-off function and having a standby power cut-off function.

Yet another exemplary embodiment of the present invention provides a power supply that can control a reservation function set in an electrical appliance to be normally executed while a standby power cut-off function is being executed by the power supply.

Yet another exemplary embodiment of the present invention provides a power supply than can supply firm power to a function module that requires prompt booting and provide a standby power cut-off function to other function module.

Yet another exemplary embodiment of the present invention provides a power supply that can cut off standby power supplied to each function module when a power-off signal of a power switch or a termination of a predetermined schedule function is detected in an electrical appliance to which a remote controller is not applied, and power is supplied to each function module when a power-on signal of the power switch is detected so as to execute power-on control.

Yet another exemplary embodiment of the present invention provides a power supply that can provide the standby power cut-off function without performing physical operation when an electrical appliance is initially connected to power after being purcharged, power is recovered after a long period of power failure, or power is connected for reuse of the electrical appliance after the plug is disconnected for a long period of time, to thereby improve safety in use and reliability of the product.

According to an embodiment of the present invention, there is provided a standby power cut-off device including: a voltage converter for converting commercial power into DC power; a charging/discharging unit for charging the DC power supplied from the voltage converter and supplying the same to a load; a voltage detector for detecting a charging level of the charging/discharging unit; a receiver for receiving power on/off control data of a remote control; a controller for executing standby power cut-off control of a designated electrical appliance in accordance with the power on/off control data of the remote control; a first switch that is switched on/off under the control of the controller to permit or cut off the commercial power (main power) supplied to the electrical appliance; a transmitter for sending the power on control data of the electrical appliance under the control of the controller; and a second switch that is switched on/off under the control of the controller to permit or cut off the commercial power (main power) supplied to the voltage converter.

Furthermore, according to an embodiment of the present invention, there is provided a standby power cut-off device including: a voltage converter for converting commercial power into DC power; a charging/discharging unit for charging the DC power supplied from the voltage converter and supplying the same as load power; a receiver for receiving power on/off control data of a remote control; a controller for executing standby power cut-off control of an electrical appliance in accordance with the received power on/off control data of the remote control; a first switch that is switched on/off under the control of the controller to permit or cut off the commercial power (main power) supplied to the electrical appliance; a transmitter for sending the power on control data of the electrical appliance under the control of the controller; a second switch for permitting or cutting off the commercial power (main power) supplied to the voltage converter; and a timer for controlling the on/off operation of the second switch in accordance with learned charging and discharging characteristics of the charging/discharging unit.

Furthermore, according to an embodiment of the present invention, there is provided a control method of a standby power cut-off device, the method including: learning power on/off control data of a remote control of each electrical appliance and storing the same in a database; determining whether the control data of the remote control is received in a standby mode; upon receipt of the control data of the remote control, determining the format of the control data by comparing the received control data of the remote control with the learned data; if the format of the control data of the remote control is the power off control data of the electrical appliance, waiting for a predetermined time and then cutting off the commercial power (main power) supplied to the target electrical appliance; and if the format of the control data of the remote control is the power on control data, normally supplying commercial power (main power) to the target electrical appliance, and sending the learned power on control data to turn on the power of the electrical appliance.

Furthermore, according to an embodiment of the present invention, there is provided a standby power cut-off device including: a voltage converter for converting commercial power into DC power; a charging/discharging unit for charging the DC power and supplying the same as load power; a voltage detector for detecting a charging level of the charging/discharging unit; a receiver for receiving a transmission signal of a remote control; a controller that learns and stores power on/off control data sent from the remote control, stores reservation information for controlling the power on/off of an electrical appliance, and sends the learned control data at a designated reservation time to execute a designated reservation function; a first switch for interrupting the commercial power (main power) supplied to the electrical appliance under the control of the controller; a transmitter for sending reservation function execution data under the control of the controller; a second switch for interrupting the commercial power (main power) supplied to the voltage converter under the control of the controller; and a display for displaying reservation setting mode entry, a set reservation time, and current time information.

Furthermore, according to an embodiment of the present invention, there is provided a control method of a standby power cut-off device, the method including: learning power on/off control data of a remote control of each electrical appliance and storing the same in a database; when the remote control sends a request for setting a reservation function, entering a reservation setting mode and giving an instruction in a predetermined format through a display; recognizing an electrical appliance designated by the remote control and reservation information (power on/off time) and storing the same in a database; starting the counter of a timer and comparing the current time with the reservation information stored in the database; and if the current time reaches a time designated in the reservation information, identifying the designated electrical appliance and the reservation function to execute the reservation function.

In addition, according to an exemplary embodiment of the present invention may provide a power supply including: a power supply unit rectifying and decreasing AC power and outputting the rectified and decreased AC power as DC power; and a standby power cut-off module disposed in an output line of the power supply unit, cutting off power supplied to a function module when a power-off signal of a remote controller is detected, and supplying the power to the function module and simultaneously executing power-on control when a power-on signal of the remote controller is detected.

The standby power cut-off module may be interfaced with a main controller of an electrical appliance and may execute a reservation function with interfaced reservation data set in the main controller of the electrical appliance in the standby power cut-off state.

The power supply unit and a function module requiring firm power may be connected with a power line to supply firm power without regard to operation of the standby power cut-off module.

The standby power cut-off module may include: a first cut-off unit disposed in the output line of the power supply unit and controlling power supplied to the function module according to control of a controller; a second cut-off unit disposed in the output line of the power supply unit and controlling power supplied to a charging/discharging unit according to control of the controller; a charging/discharging unit charged by power supplied through the second cut-off unit and supplying power to constituent elements of the standby power cut-off module; a wireless transmitting/receiving unit receiving a power on/off signal of an electrical appliance, transmitted from a remote controller and providing the received signal to the controller; an interface connected to the main controller of the electrical appliance and executing data interface; a memory storing data related to a reservation function time interfaced from the main controller of the electrical appliance; and a controller executing power control supplied to the function module from the power supply unit and power-on control according to a power on/off signal of a remote controller, exechting instantaneous charging of a charging/discharging unit by turning on a second cut-off unit for a predetermined first time, and supplying power to the standby power cut-off module with a charging voltage of the charging/discharging unit by turning off the second cut-off unit for a predetermined second time.

When a power-off signal of the remote controller is detected while the electrical appliance is in the power-on state, the controller may turn off the first cut-off unit after a predetermined time laps to cut off power supplied to each function module in the electrical appliance.

While the standby power cut-off function is being activate, the controller may turn on the first cut-off unit to supply power output from the power supply unit to each function module when a power-on signal of the remote controller is detected and may execute power-on of the electrical appliance by providing the power-on signal to a main controller of the electrical appliance through the interface.

The controller may store reservation function time data interfaced from a main controller of the electrical appliance, and, when the reservation time is detected through a counter of an internal timer, the controller may turn on the first cut-off unit to supply power to a function module of the electrical appliance and then execute power-on of the electrical appliance by providing the power-on signal to the main controller of the electrical appliance through the interface.

While the standboy power cut-off function is being activated, the controller may turn on the first cut-off unit to supply power to the function module when a power-on request of a power switch installed in a housing of the electrical appliance or a predetermined switch is detected.

The power supply may further include a voltage detector detecting a charging amount of the charging/discharging unit and providing the detected charging amount, and the controller may turn on/off the second cut-off unit with hysteresis according to the charging state of the charging/discharging unit provided from the voltage detector to maintain the charging amount of the charging/discharging unit to be higher than a predetermined voltage level while the standby power cut-off function of the electrical appliance is being activated

The predetermined first time may be a charging time determined depending on a charging characteristic of the charging/discharging unit having the instantaneous charging function, and the predetermined second time may be a discharging time of the charging/discharging unit determined depending on a discharging characteristic of the charging/discharging unit according to a power consumption amount of the entire constituent elements of the standby power cut-off module.

According to another exemplary embodiment of the present invention, a power supply includes: a power supply unit converting AC power to DC power and outputting the DC power; a first cut-off unit disposed in an output line of the power supply unit and controlling power supplied to a function module; a second cut-off unit disposed in the output line of the power supply unit and controlling power supplied to a charging/discharging unit; a charging/discharging unit charged by power supplied through the second cut-off unit and supplying power to constituent elements of a standby power cut-off module; a wireless transmitting/receiving unit transmitting a power-on/off signal transmitted from a remote controller; an interface executing data interface with a main controller of an electrical appliance; a memory storing reservation function time data interfaced from the main controller of the electrical appliance; and a controller turning off power supplied to the function module to activate a standby power cut-off function when a power-off signal of the remote controller is detected while the electrical appliance is in the power-on state, turning on the first cut-off unit to supply power to the function module when a power-on signal of the remote controller is detected while the standby power cut-off function is being activated, and executing power-on of the electrical appliance by providing the power-on signal to the main controller of the electrical appliance through the interface.

When reservation data is detected according to a timer counter while the standby power cut-off function is being activated, the controller may thrn on the first cut-off unit to supply power to the function module and executes power-on by interfacing the power-on signal to the main controller of the electrical appliance.

When a power-on request from a power switch or a predetermined switch is detected while the standby power cut-off function is being executed, the controller may turn on the first cut-off unit to supply power to the function module and may interface the power-on signal to the main controller of the electrical appliance.

The power supply may further include a third cut-off unit disposed in one of power supply lines of the power supply unit, and the third cut-off unit may control AC power supplied to the power supply unit according to control of the controller.

The controller may instantaneously charge the charging/discharging unit by turning on the second cut-off unit for a predetermined first time determined depending on a charging characteristic of the charging/discharging unit, and may turn off the second cut-off unit for a predetermined second time determined depending on a discharging characteristic of the charging/discharging unit according to a power consumption amount of the entire constituent elements of the standby power cut-off module.

The power supply may further include a voltage detector detecting a charging state of the charging/discharging unit, and the controller may instantaneously charge the charging/discharging unit by turning on the second cut-off unit when the charging amount of the charging/discharging unit provided from the voltage detector is lower than a predetermined first voltage, may terminate a charging operation by turning off the second cut-off unit when the charging amount of the charging/discharging unit is detected to be higher than a predetermined second voltage, and may control turn-on/turn-off of the second cut-off unit with hysteresis according to the charging amount of the charging/discharging unit.

In addition, according to another exemplary embodiment of the present invention, a power supply includes: a power supply unit converting AC power to DC power and outputting the DC power; a first cut-off unit disposed in a power supply line of the power supply unit and controlling AC power supplied to the power supply unit; a controller controlling AC power supplied to the power supply unit by turning off the first cut-off unit when a power-off signal of a power switch is detected and supplying AC power to the power supply unit by turning on the first cut-off unit when a power-on signal of the power switch is detected; a charging/discharging unit supplying power to the controller while a standby power cut-off function is being activated; a second cut-off unit controlling AC power to the charging/discharging unit according to control of the controller; and an interface connected with a main controller of an electrical appliance and interfacing reservation related data and operation data.

When a scheduled function set tin the electrical appliance is detected, the controller may turn off the first cut-off unit to control AC power supplied to the power supply unit to activate the standby power cut-off function.

While the standby power cut-off function is being activated, the controller may charge the charging/discharging unit by turning on the second cut-off unit for a predetermined first time and may turn off the second cut-off unit for a predetermined second time to normally maintain the charging/discharging unit with a voltage higher than a predetermined voltage level.

When reservation information interfaced from the main controller of the electrical appliance and then stored, the controller may turn on the first cut-off unit at a predetermined reservation time to supply AC power to the power supply unit and may provide a trigger signal to the main controller through the interface to thereby execute a predetermined reservation function.

The charging/discharging unit may include a rectifying means to convert AC power to DC power, and may be formed of a super capacitor having an instantaneous charging function.

The power supply may further include a voltage detector providing charging amount data of the charging/discharging unit while the standby power cut-off function is being activated. The controller may monitor data provided from the voltage detector, and may instantaneously charge the charging/discharging unit with AC power by turning on the second cut-off unit when the charging amount of the charging/discharging unit is lower than a predetermined first voltage, terminate charging operation by turning off the second cut-off unit when the charging amount of the charging/discharging unit is higher than a predetermined second voltage, and control turn-on/turn-off of the second cut-off unit with hysteresis according to the charging amount of the charging/discharging unit.

According to still another exemplary embodiment of the present invention, a power supply includes: a power supply unit converting AC power to DC power and outputting the DC power; a second cut-off unit controlling AC power supplied to the power supply unit; a first cut-off unit controlling power supplied to a function module from the power supply unit; a charging/discharging unit charged by output power of the power supply unit and supplying power to constituent elements of a standby power cut-off module; a voltage detector detecting a charging amount of the charging/discharging unit and providing the detected charging amount; a controller cutting off power supplied to the power supply unit and function modules by turning off the first and second cut-off units when a power-off signal of a power switch is detected, and controlling the power supply unit and the function modules to be executed by turning on the first and second cut-off units when a power-on signal is detected; and an interface connected with a main controller of an electrical appliance and providing an interface of reservation-related data and operation data.

The controller normally may maintain the charging/discharging unit to be higher a predetermined voltage level with output power of the power supply unit by turning on/off the second cut-off unit while the first cut-off unit is being turned off according to the charging amount of the charging/discharging unit, detected through the voltage detector.

The controller may supply power to each function module by turning on the first and second cut-off units at a reservation time interfaced from the main controller of the electrical appliance and then stored, and may execute a predetermined reservation function by providing a trigger signal to the main controller of the electrical appliance through the interface.

The controller may turn on the second cut-off unit when the charging/discharging unit is discharged to be lower than a predetermined voltage level when a power failure occurs or a plug is disconnected, and the second cut-off unit formed with a latch-type switch may continuously maintain the switch-on state until switch-off control of the controller is executed to execute charging operation of the charging/discharging unit without physical operation when a power failure occurs for a long period of time, the electrical appliance is initially connected to power after being purchased, or a plug of the electrical appliance is connected for reusing after long period of disconnection.

The standby power cut-off device according to the present invention cuts off the commercial power (main power) supplied to an electrical appliance in accordance with control data of a remote control for turning off the power of the electrical appliance to avoid standby power consumption generated in a standby state for the function of the electrical appliance such that unnecessary power consumption can be prevented and energy consumption can he highly effectively reduced.

Moreover, even if overcurrent is generated in a power line due to lightning strikes in the power-off state of the electrical appliance, the overcurrent is prevented from flowing into the electrical appliance, thereby stably protecting the appliance, and power is supplied only during the execution of the function of the electrical appliance, thereby extending the durability life of the parts and offering stability and reliability to the use of the appliance.

Further, even when the commercial power (main power) supplied to the electrical appliance is completely cut off, commercial power (main power) is firstly supplied to the electrical appliance in accordance with control data of the remote control for tuning on the power of the electrical appliance, and thereafter learned power on control data is sent to turn on the power of the corresponding electrical appliance, thereby offering convenience and reliability in the use of the appliance.

In addition, even when the commercial power (main power) supplied to the electrical appliance is completely cut off, a reservation function is executed to execute the power on/off control of the electrical appliance, thereby offering convenience and reliability in the use of the appliance.

In addition, although a standby power cut-off function is executed according to a power-off signal of a remote controller, power supply to elements that require firm power can be maintained so that energy consumption can be highly effectively reduced and reliability of the product can be improved by promptly responding to power-on operation.

In addition, a reservation function set in the electrical appliance can be normally operated even though the standby power is cut-off by the power supply so that reliability of the product can be improved.

In affition, a standby power cut-off function and power-on control are executed according to a power-on/off signal of a power switch in an electrical appliance to which a remote controller is not applied so that energy efficiency grade of various electrical appliances having relatively long standby hours, such as a laundry, a dish-washer, a microwave, and the like can be increased.

Further, when an electrical appliance is initially connected to power after being purcharged, power is recovered after a long period of power failure, or power is connected for reuse of the electrical appliance after the plug is disconnected for a long period of time, the standby power cut-off function is provided without performing physical operation to thereby improve safety in use and reliability of the product.

### BRIEF DESCRIPTION OF THE DRAWINGS

FIG. 1 is a view schematically illustrating the configuration of a standby power cut-off device according to a first exemplary embodiment of the present invention.

FIG. 2 is a view illustrating a schematic configuration of a standby power cut-off device according to a second exemplary embodiment of the present invention.

FIG. 3 is a view illustrating a connection state between a power strip to which the standby power cut-off device is applied according to an exemplary embodiment of the present invention and electrical equipment.

FIG. 4 is a flowchart of a learning procedure of a remote controller for power on/off control data, related to the standby power cut-off device according to the exemplary embodiment of the present invention.

FIG. 5 is a view illustrating a power control procedure of the standby power cut-off device according to the exemplary embodiment of the present invention.

FIG. 6 is a view schematically illustrating the configuration of a standby power cut-off device according to a third exemplary embodiment of the present invention.

FIG. 7 is a flowchart illustrating a reservation time setting procedure of the standby power cut-off device according to the third exemplary embodiment of the present invention.

FIG. 8 is a flowchart illustrating a reservation function execution procedure of the standby power cut-off device according to the third exemplary embodiment of the present invention.

FIG. 9 schematically shows a configuration of a standby power cut-off device according to a fourth exemplary embodiment of the present invention.

FIG. 10 is a view illustrating a power supply supplied with a standby power cut-off function according to fifth and sixth exemplary embodiments of the present invention.

FIG. 11 is a view illustrating a power supply supplied with a standby power cut-off function according to seventh and eight exemplary embodiments of the present invention.

FIG. 12 is a view illustrating a power supply supplied with a standby power cut-off function according to ninth and tenth exemplary embodiments of the present invention.

FIG. 13 is a view illustrating a power supply supplied with a standby power cut-off function according to eleventh and twelfth exemplary embodiments of the present invention.

### DETAILED DESCRIPTION OF THE EMBODIMENTS

The present invention will be described more fully hereinafter with reference to the accompanying drawings, in which exemplary embodiments of the invention are shown. However, it is to be understood that the invention is not limited to the disclosed embodiments.

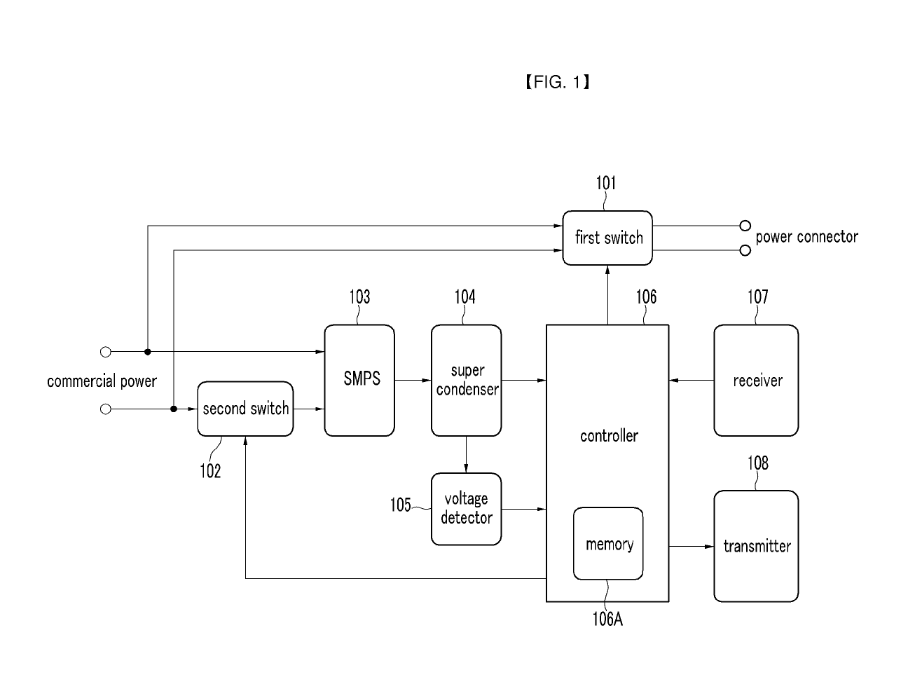

FIG. 1 is a view schematically illustrating the configuration of a standby power cut-off device according to a first exemplary embodiment of the present invention.

The standby power cut-off device according to the present invention includes a first switch 101, a second switch 102, a switching mode power supply (SMPS) 103, a super condenser 104, a voltage detector 105, a controller 106, a receiver 107, and a transmitter 108.

In the drawings, the term “commercial power” refers to power that comes from a socket by plugging the plug of a power strip, to which the present invention is applied, into a socket installed in a wall of a building or other connecting means extending from the socket.

Further, the term “power connector” refers to at least one socket provided in a power strip to which the present invention is applied, into which the plug of an electrical appliance is plugged.

The first switch 101 supplies or cuts off the commercial power (main power) that is input to an electrical appliance connected to a power connector (socket) by on/off switching operations in response to a control signal of the controller 106.

For example, when the electrical appliance is in a power-on state, it is switched on to normally supply commercial power (main power) to the electrical appliance connected to the power connector, and when the electrical appliance is in a power-off state, it is switched off to cut off the supply of commercial power (main power) to the electrical appliance connected to the power connector, thereby completely cutting off the consumption of standby power.

Various types of switching means including an SCR, a triac, a photocoupler, a relay transistor, an FET, etc may be used as the first switch 101.

The second switch 102 is switched on/off under the control of the controller 106 to supply or cut off input commercial power (main power) to the SMPS 103.

For example, in a state in which the first switch 101 is switched on and supplies power to the electrical appliance connected to the power connector, the power is supplied to a load that is switched on and includes the power strip according to the present invention, whereas in a state in which the electrical appliance connected to the power connector is powered off to cut off standby power, the first switch 101 is switched off to minimize the consumption of standby power generated in the power strip.

The first switch 101 may be switching means of various types, including an SCR, a triac, a photocoupler, a relay transistor, a FET, etc. The first switch 101 is switched on/off in accordance with a voltage charged in the super condenser 104 so that the super condenser 104 is maintained at more than a predetermined voltage.

The SMPS 103 converts the commercial power (main power) input by switching on the second switch 102 into DC power (constant voltage), and supplies it as a charging voltage to the super condenser 104.

The super condenser 104, as charging means, is charged with the DC power supplied from the SMPS 103 and supplies it as operating power to the controller 106, and supplies a normal operating power to the controller 106 even when the second switch 102 is switched off.

The voltage detector 105 detects a voltage of the super condenser 104 and provides information on charging capacity to the controller 106, so that the super condenser 104 maintains a predetermined voltage level.

The controller 106 learns power on/off control data of a remote control for remotely controlling the electrical appliance connected to the power connector through the receiver 107, and stores it in a data table of the memory 106A.

Upon receipt of control data of the remote control for turning off the power of the electrical appliance by wireless communication through the receiver 107, if the control data matches the learned control data, the controller 106 switches off the first switch 101 to cut off the commercial power (main power) supplied to the electrical appliance connected to the power connector so that standby power consumption does not occur in the electrical appliance, and switches off the second switch 102 to cut off the standby power of the electrical appliance, thereby minimizing the standby power consumption of the power strip to which the present invention is applied.

Upon receipt of the control data of the remote control for turning off the power of the electrical appliance by wireless communication, the controller 106 switches off the first switch 101 after a predetermined time to turn off the power of the electrical appliance in accordance with power off control data of the remote control, and cuts off commercial power (main power) after the stabilization of the electrical appliance is achieved, thus avoiding damage to and errors of the electrical appliance.

Moreover, upon receipt of the control data of the remote control for turning on the power of the electrical appliance by wireless communication in a state in which the commercial power (main power) supplied to the electrical appliance connected to the power connector is cut off by switching off the first switch 101, if the control data matches the learned control data, the controller 106 switches on the first switch 101 to supply commercial power (main power) to the electrical appliance, and then sends the learned power on control data of the electrical appliance to the electrical appliance through the transmitter 108 to turn on the power of the electrical appliance by sending.

That is, upon receipt of the power control data of the remote control when the electrical appliance is in an operating condition for keeping the power on, the controller 106 cuts off commercial power (main power) after the power of the electrical appliance is turned off, thus avoiding standby power consumption, and upon receipt of the power on control data of the remote control when the power of the electrical appliance is kept off and commercial power (main power) is cut off, the controller 106 firstly supplies the cut-off commercial power (main power) and then sends the learned power on control data to the electrically appliance to turn on the power.

The controller 106 minimizes standby power consumption in the power strip, in which the present invention is configured, by turning off the second switch 102 when the first switch 101 is turned off to cut-off the commercial power (main power) supplied to electrical appliance, and controls stable power to be supplied to each load of the power strip by turning on the second switch 102 when the first switch 101 is turned on.

The controller 106 is put into operation by being supplied with the power charged in the super condenser 104, determines a voltage level charged in the super condenser 104 in accordance with information provided from the voltage detector 105, and controls the on/off of the second switch 102 in accordance with the determined voltage level to stably maintain the level of the power charged in the super condenser 104, thereby controlling standby power consumption of the power strip, in which the present invention is configured, to a minimum level.

That is, if the voltage level of the super condenser 104 provided from the voltage detector 105 is a preset lower limit reference level, the controlled 106 turns on the second switch 102 to execute charging of the super condenser 104, and if the voltage level of the super condenser 104 reaches a preset upper limit reference level in accordance with a charging operation, the controller 106 turns off the second switch 102.

A memory 106A learns the power on/off data of the remote control for remotely controlling the electrical appliance and stores it as a database.

The receiver 107 receives the power on/off control data provided by wireless communication, preferably infrared ray (IR) communication, from the remote control for remotely controlling the electrical appliance, and provides it to the controller 106.

The receiver 107 may be configured in various ways according to a communication scheme established for the remote control, and, for example, may be configured as a receiver for receiving Bluetooth, Zigbee, radio frequency (RF), etc.

The transmitter 108 sends power on control data to the electrical appliance by wireless communication, preferably IR communication, under the control of the controller 106 so that the power of the electrical appliance is turned on.

The transmitter 108 may be configured in various ways according to a communication scheme established for the remote control for remotely controlling the on/off the power of the electrical appliance, and for example, may be configured as a receiver for receiving Bluetooth, Zigbee, radio frequency (RF), etc.

Moreover, the receiver 107 and the transmitter 108 may be variously configured according to settings, including a method of receiving IR communication power on/off data and transmitting IR communication power on data, a method of receiving IR communication power on/off data and transmitting RF communication power on data, a method of receiving RF communication power on/off data and transmitting RF communication power on data, and a method of transmitting RF communication power on/off data and transmitting IR communication power on data.

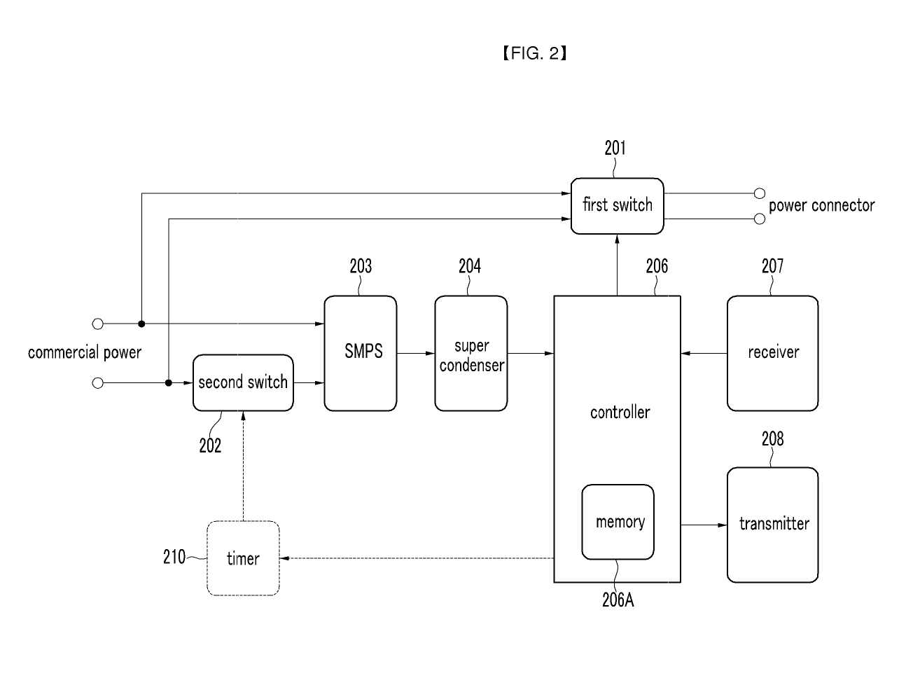

As illustrated in FIG. 2, a timer 210, instead of the voltage detector 105 that is applied to the configuration of the first exemplary embodiment, is applied to the configuration of the second exemplary embodiment according to the present invention, and the configurations of a first switch 201, a second switch 202, an SMPS 203, a super condenser 204, a controller 206, a receiver 207, and a transmitter 208, which are the remaining components, are identical or similar to the configurations of the first exemplary embodiment, so detailed descriptions thereof will be omitted.

The controller 206 learns charging and discharging characteristics of the super condenser 204 with regard to the power consumption of the entire load elements configured in the present invention and sets them in the memory 206A, and controls the resetting of the timer 210 and the start of the counter in accordance with the learned charging and discharging characteristics of the super condenser 204 in a state in which the commercial power (main power) supplied to the electrical appliance is cut off by switching off the first switch 201.

The timer 210 is operated in response to a control signal of the resetting and the starting of the counter applied from the controller 206 to switch the second switch 202 on/off, thus adjusting the charging voltage supplied to the super condenser 204 and stably maintaining the voltage level.

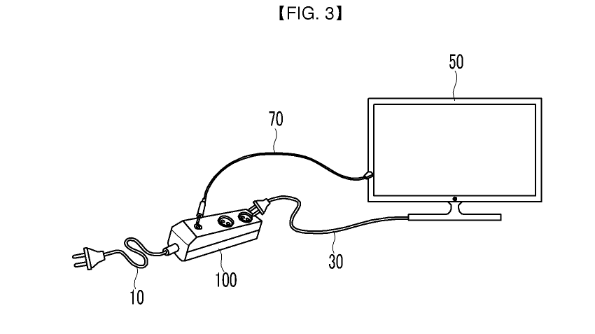

As illustrated in FIG. 3, a plug 10 configured in a power strip 100 is plugged into a socket installed in a wall of a house or building, and electrical appliances 50 of various types are respectively connected to at least one socket configured in the power strip 100.

Also, the power strip 100 and the electrical appliance 50 are connected by a separate wire 70 to send and receive control data for turning the power of the electrical appliance on/off.

Moreover, in the configuration according to FIGS. 1 and 2, it is necessary to ensure an environment of good wireless communication for the receiver 107 and 207 and the transmitter 108 and 208. Thus, the receiver and the transmitter can be configured with independent modules separate from the power strip to which the present invention is applied, and can be installed in an area where a good communication environment is ensured, and the independent modules and the power strip can be connected by wires so that the transmission and reception of the power on/off control data of the remote control may be achieved.

Further, since the power strip is usually installed at a poorly visible position because of the aesthetic appearance of the interior, it is preferable that a signal sent from the remote control for remotely controlling the electrical appliance and a signal for turning on the power of the electrical appliance are transmitted with directivity to a specific direction, and, if required, a separate structure such as a reflection plate can be further installed.

Although it is preferable that the above configuration according to the exemplary embodiment of FIGS. 1 and 2 is configured as a power strip, a technology of providing the above configuration directly to a socket installed in a wall surface or the like can be employed. Thus, a description thereof is included in the scope of the present invention.

The operation of the present invention configured by including the above-described function will be described below.

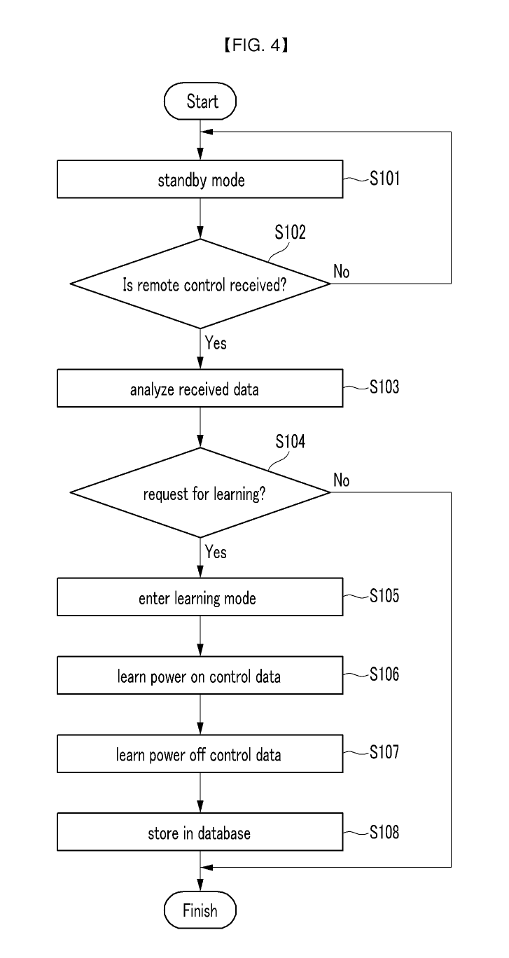

First, the operation of learning the power on/off control data of the remote control for remotely controlling respective electrical appliances connected to a power connector having a plurality of sockets provided in the power strip according to the present invention will be described in detail with reference to FIG. 4.

If the plug 10 is plugged into a socket installed in a wall surface or the like in order to allow the power strip 100 according to the present invention to learn the power on/off control data of the electrical appliance, the controller 106 keeps the second switch 102 switched on in an initial state, thereby supplying the SMPS 103 with commercial power (main power) input through the socket and the plug 10.

The SMPS 103 converts an input commercial power (main power) into DC power (constant voltage) and supplies it as a charging voltage to the super condenser 104, and the super condenser 104 supplies the charged power to the controller 106 to thus allow the controller 106 to enter a standby mode for learning the power on/off control data of the remote control (S101).

In the standby mode, the controller 106 determines whether a radio communication signal of the remote control is received through the receiver 107 (S102).

When no radio communication signal of the remote control is received in the step S102, the routine returns to the step S101, and when a radio communication signal of the remote control is received, received data is analyzed (S103) to determine whether there is a request for learning the control data for controlling the on/off of the power of the electrical appliance (S104).

In the determination of the step S104, if there is no request for learning the power on/off control data of the remote control, the received remote control signal is ignored, and if there is a learning request, the controller enters a learning mode of the power on/off control data (S105).

Afterwards, the power on control data and power off control data of the remote control input through the receiver 107 are learned (S106) (S107), and the learned power on/off control data is stored as a database in the memory 106A (S108).

The learning of the power on/off control data of the remote control is executed for each electrical appliance by matching an ID (identification number) assigned to each socket to the electrical appliance.

For example, under the assumption that the power plug of a television is plugged into a first socket of the power strip to which the present invention is applied, the power plug of a DVD player is plugged into a second socket, and the power plug of an air conditioner is plugged into a third socket, IDs (identification numbers) assigned to the respective sockets and the power on/off control data of the electrical appliances connected to the respective sockets are matched with each other and stored as a database.

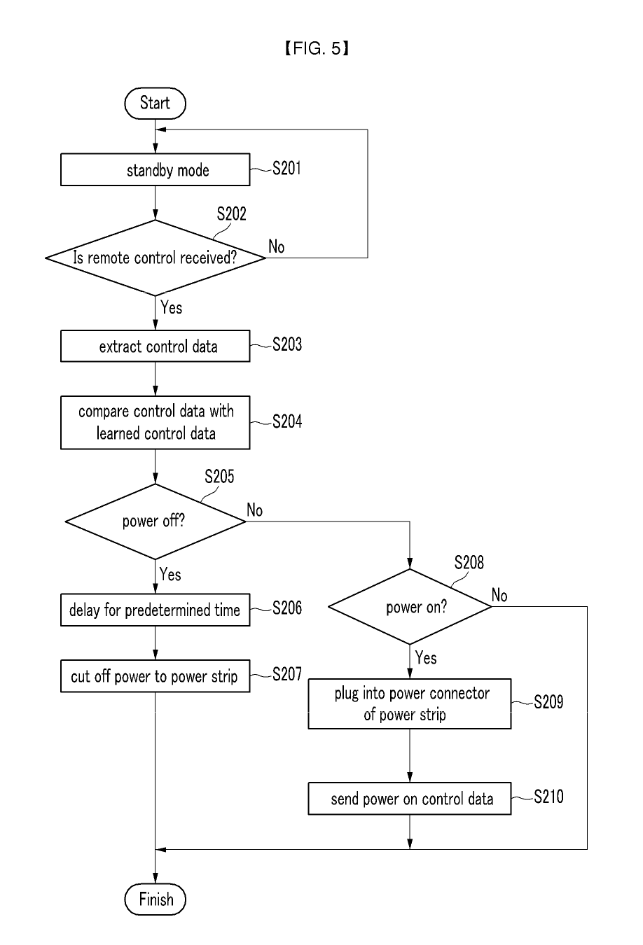

The operations of cutting off standby power generated in an electrical appliance connected to a socket and controlling the power on/off upon receipt of the power on/off control data of the remote control when the power on/off control data of the electrical appliance is learned and stored as a database as described above will be described below (refer to FIG. 5).

In a state in which the controller 106 waits for an operation to be performed by power supplied from the super condenser 104 (S201), it is determined whether a radio communication signal of the remote control is received through the receiver 107 (S202).

When no radio communication signal of the remote control is received in the step S202, a remote control signal is continuously waited for, and when a radio communication signal of the remote control is received, control data is extracted (S203) and is then compared with learned control data stored as a database in the memory 106A to determine the format of the control data (S204).

It is determined whether the format of the control data is control data for controlling the power-off of the electrical appliance connected to the socket (S205).

In the determination of the step S205, if the power off control data of the electrical appliance is received, the power of the electrical appliance is turned off by a radio communication signal sent from the remote control and then the operation is delayed for a preset period of time for stabilization (S206), and then the first switch 101 is turned off after the passage of a predetermined time to cut off the commercial power (main power) supplied to the electrical appliance plugged into the power connector, which is a socket.

In the course of controlling the switching off of the first switch 101, the ID (identification number) of the plug matching with the control data received from the remote control is extracted from the database to identify the position of the socket into which the plug of the electrical appliance to be controlled is plugged, and the switching operation of commercial power (main power) is executed for the corresponding socket.

Accordingly, the commercial power (main power) supplied to the electrical appliance is cut off, thereby preventing standby power consumption.

When the first switch 101 is turned off to cut off the commercial power (main power) supplied to the electrical appliance connected to the power connector as described above, the controller 106 determines a charging level of the super condenser 104 through the voltage detector 105 to determine whether the super condenser 104 is at a preset fully charged condition.

If the charging level of the super condenser 104 does not reach the fully charged condition, the charging operation is continuously performed with DC current supplied through the SMPS 103. If the charging level of the super condenser 104 reaches the preset fully charged condition, the second switch 102 is turned off to cut off the commercial power supplied to the SMPS 103, thereby minimizing standby power consumption of the power strip.

In a state in which the commercial power is input into the SMPS 103 by turning off the second switch 102, the controller 106 continuously maintains a standby state by the charging power provided by the super condenser 104.

Also, the power charged in the super condenser 104 is consumed by the standby operation of the controller 106 which is a load, and the voltage detector 105 detects a charging level of the super condenser 104 and provides it to the controller 105.

At this point, if the charging level of the super condenser 140 detected by the controller 106 is determined as a preset lower limit reference level, the controller 106 switches on the second switch 102 to supply commercial power to the SMPS 103, and allows the super condenser 104 to be charged with DC power output from the SMPS 103.

As seen from the above, the controller 106 detects the charging level of the super condenser 104 by the voltage detector 105 and controls the switching on/off operation of the second switch 102, thereby minimizing standby power consumption generated in the power strip.

Moreover, in another exemplary embodiment, as illustrated in FIG. 2, when the controller 206 turns off the first switch 201 to cut off the commercial power (main power) supplied to the electrical appliance connected to the power connector as described above, the switching on/off operation of the second switch 202 is controlled by controlling the counter of the timer 210 in accordance with learned charging and discharging characteristics of the super condenser 204, thereby allowing the charging level of the super condenser 204 to be in a stable condition.

Therefore, standby power consumption generated in the power strip can be minimized.

Further, in the determination of the step S205, it is determined whether power off control data of the electrical appliance is received or power on control data of the electrical appliance is received (S208).

In the determination of the step S208, if power on control data is received, the controller 106 switches on the first switch 101 in the switched-off state to normally supply commercial power (main power) to the electrical appliance plugged into the power connector (S209).

In the course of controlling the first switch 101 to be switched on, the ID (identification number) of the plug matching the control data received from the remote control is extracted from the database to identify the position of the socket into which the plug of the electrical appliance to be controlled is plugged, and the switching operation of commercial power (main power) is executed for the corresponding socket.

Also, the second switch 102 is switched on to supply commercial power (main power) to the SMPS 103.

Thereafter, access is made to the power on control data of the electrical appliance learned and stored in the memory 206A, and then the power on control data is sent by wireless communication through the transmitter 208, thereby turning on the power of the electrical appliance in the power-off state (S210). Therefore, the normal function of the electrical appliance is maintained.

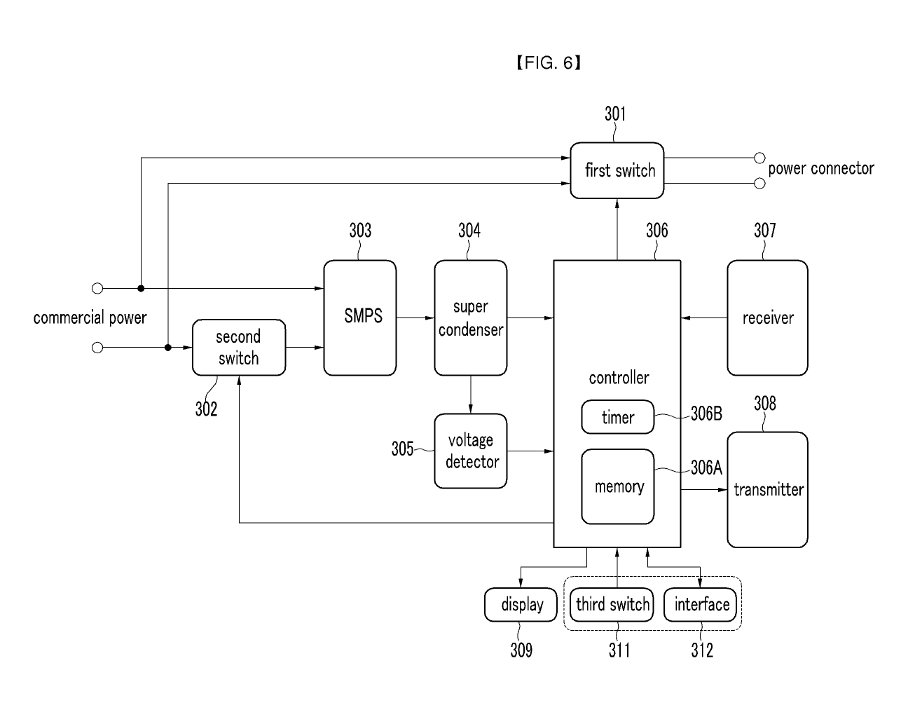

FIG. 6 is a view schematically illustrating the configuration of a standby power cut-off device according to a third exemplary embodiment of the present invention.

Like the configuration of the first exemplary embodiment, the configuration according to the third exemplary embodiment of the present invention includes a first switch 301, a second switch 302, an SMPS 303, a super condenser 304, a controller 3, a receiver 307, and a transmitter 308, and further includes a display 309 composed of a liquid crystal display device (refer to FIG. 6).

The components of the third exemplary embodiment identical or similar to those of the first exemplary embodiment have identical or similar functions as those of the first exemplary embodiment, so detailed descriptions of the components will be omitted.

In the configuration of the third exemplary embodiment according to the present invention, the controller 306 learns power on/off control data of each electrical appliance connected to a socket in accordance with a request from the remote control and stores it as a data base in the memory 306A, and stores a reservation time for controlling the power on/off of the electrical appliance connected to the socket as a database in the memory 306A in a reservation function learning mode.

The power on/off reservation time of the electrical appliance stored as a database in the memory 306A is stored, matched with a plurality of electrical appliances with identification numbers (IDs) assigned to the respective sockets.

The reservation time for power on/off is set for the alarm function of an electrical appliance, a programmed recording function, and the programmed operation of cooling and heating equipment.

Moreover, the controller 306 determines whether the reservation time set in the memory 306A has been reached in accordance with the counter of a timer 306B, and, if the reservation time has been reached, recognizes whether there is a power-on request or a power-off request, and identifies the corresponding electrical appliance and outputs a control signal for executing the function programmed for the corresponding electrical appliance and the power on/off operation.

For instance, if the controller 306 is programmed to control the power of the electrical appliance to be turned on, the controller 306 firstly switches on the first switch 301 at a reservation time corresponding to the counter of the timer 306B and supplies commercial power (main power) to the target electrical appliance to put the electrical appliance into a standby state, and then sends power on data by wireless communication through the transmitter 108 to turn on the power of the electrical appliance.

Further, if the controller 306 is programmed to control the power-off of the electrical appliance that is kept powered on, the controller 306 sends power off control data by wireless communication through the transmitter 308 at a reservation time corresponding to the counter of the timer 306B to turn off the power of the electrical appliance to be controlled, waits for a predetermined time for stabilization of the electrical appliance controlled to be turned off and then turns off the first switch 301 to cut off the supply of commercial power (main power), thereby avoiding damage to and errors of the electrical appliance.

Also, if the first switch 101 is switched off, the second switch 302 is switched off in conjunction with the first switch 101 to minimize standby power consumption of the power strip in which the present invention is configured, and if the second switch 302 is switched on, the second switch 302 is switched on in conjunction with the second switch 302 to supply stable power to each load of the power strip.

The display 309 displays time information under the control of the controller 306, and displays power on/off time information set in a reservation mode.

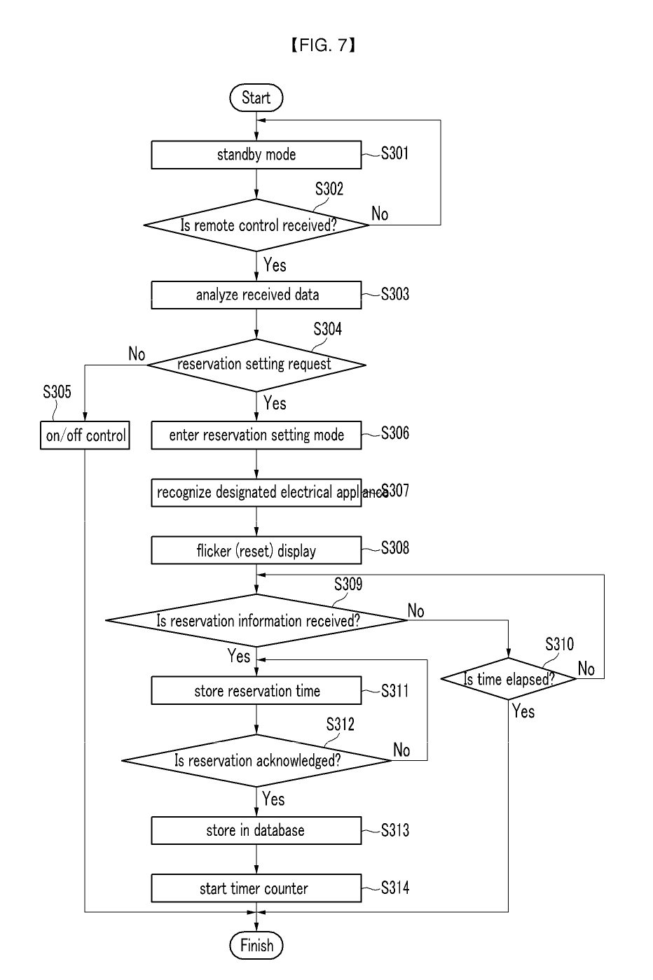

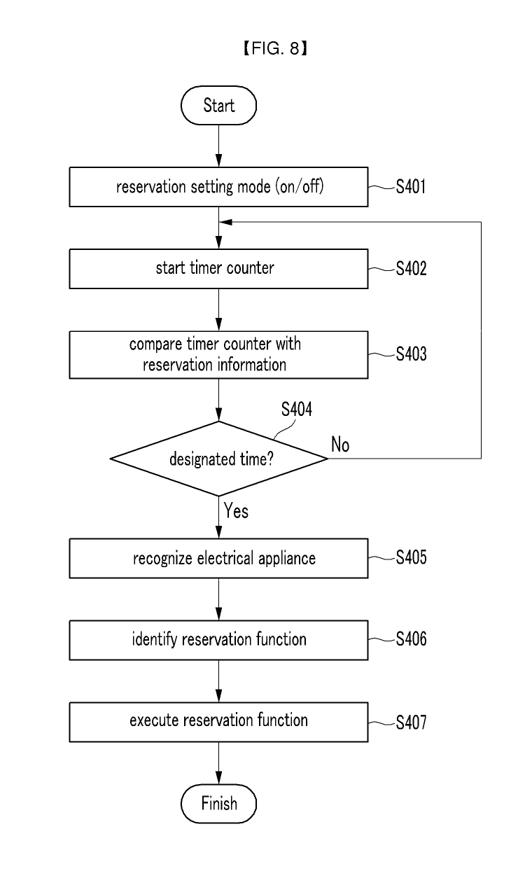

The execution of the aforementioned reservation function will be described below with reference to FIGS. 7 and 8.

In the third exemplary embodiment of the present invention, the above-described functions of the first and second exemplary embodiments are applied as is to an operation of cutting off standby power in response to a control signal of the remote control, the power-on control operation of an electrical appliance, and an operation of controlling internal power, so a detailed description of these functions will be omitted.

In a state in which the controller 306 waits for an operation to be performed by power supplied from the super condenser 304 (S301), it is determined whether a signal of a remote control is received through the receiver 107 (S302).

When a signal of the remote control is received in the step S302, received data is analyzed (S303) to determine whether there is a reservation setting request (S304).

If it is determined that there is no reservation setting request in the step S304, on/off control operations for standby power cut-off, power-on control of an electrical appliance, and internal power control are executed by the above-described operation in accordance with the received signal (S305).

However, if it is determined that there is a reservation setting request in the step S304, the controller 306 enters a reservation setting mode (S306), and analyzes the received signal of the remote control and identifies the electrical appliance designated for setting reservation functions, such as power on/off (S307).

Also, the user is notified that the controller 306 has entered the reservation setting mode by flickering the display 309 (S308).

If the controller 306 has entered the reservation setting mode, reservation time information currently set for the designated electrical appliance is flickered or initialized.

When it is notified by the flickering of the display 309 that the controller 306 has entered the reservation setting mode as described above, it is determined whether reservation information for designating power on/off time is received from the remote control or not (S309).

In the determination of the step S309, if no reservation information is received, it is determined whether the set time has passed (S310). If the set time is not passed, the routine returns to the step S309 to continuously wait for the reception of reservation information, or if the set time has passed, it is determined that the designated time has passed and the reservation setting mode is finished.

However, in the determination of the step S309, when reservation information is received, the time for designating power on/off is temporarily stored (S311), and when a signal for acknowledging a reservation setting is received, the identified electrical appliance, the reservation information (power on/off time and learned power on/off control data), and the ID of the socket are matched with each other and stored in the database of the memory 306A (S313).

Regarding the aforementioned setting of reservation information, if electrical appliances, such as an air conditioning system, a boiler, a television, or a VCR, are respectively connected to a plurality of sockets configured in a power strip, and reservation information is set for the respective electrical appliances to achieve programmed cooling/heating, programmed recording, alarm function, etc., the reservation information (designated power on/off time) set for a corresponding electrical appliance and identification information of the socket are matched with each other and stored in the memory 306A.

In accordance with the above-described operation, if reservation information of each electrical appliance connected to a socket configured in the power strip according to the present invention, the counter of the timer 306B is started to execute the reservation function (S314).

A procedure of executing the set reservation function with the passage of time when reservation information is set for the power strip applied to the standby power cut-off device according to the present invention through the above-described process will be described below with reference to FIG. 8.

Upon completion of the setting of the reservation function through the above-described procedure of FIG. 7 (S401), the controller 306 starts the counter of the timer 306B (S402), compares the current time information with the reservation information for power on/off control stored in the database of the memory 306A (S403), and determines whether the current counted time reaches a designated reservation time for power on/off control (S404).

In the determination of the step S404, if the current counted time reaches a designated reservation time, the designated electrical appliance and the socket that connects to the corresponding electrical appliance are recognized (S405), and it is identified whether the reservation function is set for power-on control or set for power-off control (S406).

When the electrical appliance designated for the reservation function and the reservation function designated for power on/off control are identified, power on/off control data of the electrical appliance is transmitted by wireless communication through the transmitter 308 so that the power on/off control of the target electrical appliance is executed (S407).

If the power of the electrical appliance is controlled to be turned on, the controller 306 firstly switches on the first switch 301 to supply power to the corresponding electrical appliance and then send the power on control data of the corresponding electrical appliance learned by the transmitter 308 so that the power on control using the reservation function is executed.

Therefore, if a wake-up alarm is set using a television, for example, the power on control of the television is executed at a designated reservation time, if programmed recording is set for a VCR, the power on control of the television and VCR is executed at a designated time, and if there is a setting for cooling and heating, the power of an air conditioning system or boiler is controlled to be turned on at a designated time.

Moreover, if the power of the electrical appliance is controlled to be turned off by the above reservation function, the controller 306 sends power off control data of the corresponding electrical appliance through the transmitter 308 to control the power of the electrical appliance to be turned off, and waits for a predetermined time after the power off control of the electrical appliance, during which stabilization is performed, and then switches off the first switch 301 to cut off commercial power (main power) supplied to the electrical appliance, thereby avoiding standby power consumption.

Therefore, the power off control for a sleep function while watching the television, the completion of programmed recording of the VCR, and so on are executed so as to prevent excess power consumption.

Like the configuration according to the third exemplary embodiment of the present invention illustrated in FIG. 6, a configuration according to a fourth exemplary embodiment of the present invention includes a first switch 401, a second switch 402, a SMPS 403, a super condenser 404, a controller 406, a receiver 407, a transmitter, and a display 409, and is formed as an indepent module by further including a third switch 410 and an interface 411. The indepent module is mounted on a power supply of an electrical appliance to perform a time-related function such as a reservation function according to user's selection.

In the description of the fourth exemplary embodiment, constituent elements that are the same or similar to the constituent elements of the third exemplary embodiment have the same or similar function, and therefore no further description will be provided.

The third switch 410 is a power switch of an electrical appliance or a predetermined switch. For example, one of a volume up/down switch and a channel up/down switch may be used as the third switch 410, and a user's switching operation executes a controller 406 in the activated state.

The interface 411 is connected with a main controller of an electrical appliance to interface time-related data including a reservation function set in an electrical appliance and store the data in a memory 406A of the controller 406.

Thus, the controller 406 turns off the first switch 401 at a power-off reservation time stored in the memory 406A to cut-off main power supply to thereby block standby power consumption.

In addition, when the first switch 401 is turned off and thus the third switch 410 selected by the user is turned on while standby power supplied to the electrical appliance is cut-off, the controller 406 is activated and turns on the first switch 401 to supply the main power to the power supply of the electrical appliance during the cut-off time.

Further, the controller 406 turns on the first switch 401 at a power on reservation time stored in the memory 406A to supply the main power to the power supply of the electrical appliance to thereby function a power on reservation function of the electrical appliance.

Therefore, the power on/off reservation functions and time-related functions of the electrical appliance are executed.

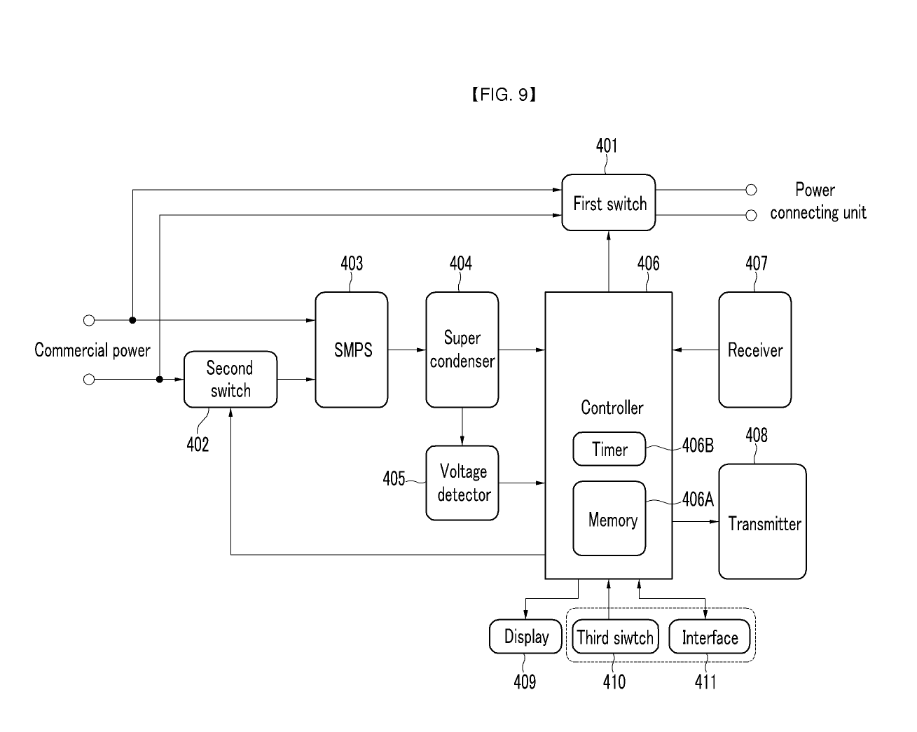

For instance, standby power cut-off and designated reservation functions can be normally executed by additionally configuring the standby power cut-off device having the configuration of FIG. 9 as an independent module in a power supply of an electrical appliance, such as a washing machine or macrowave oven, to which a remote control is not applied, thereby offering reliability and convenience in the user of the standby power cut-off device.

A fifth exemplary embodiment of the present invention is applied to a power supply mounted on an electrical appliance to which a remote controller is applied. According to the fifth exemplary embodiment, standby power cut-off and power on control can be executed according to a power on/off signal transmitted from the remote controller.

The fifth exemplary embodiment of the present invention is applied to an electrical appliance on which a function module that requires commercial power.

For example, when a hard disk requiring a booting time is installed as a function module in an electrical appliance, e.g., an IPTV or a smart TV, firm power is supplied all the time to the hard disk to thereby improve responsiveness with respect to power on.

That is, although standby power is cut off according to power off, power supply to the function modules requiring consistent power supply cane stably maintained.

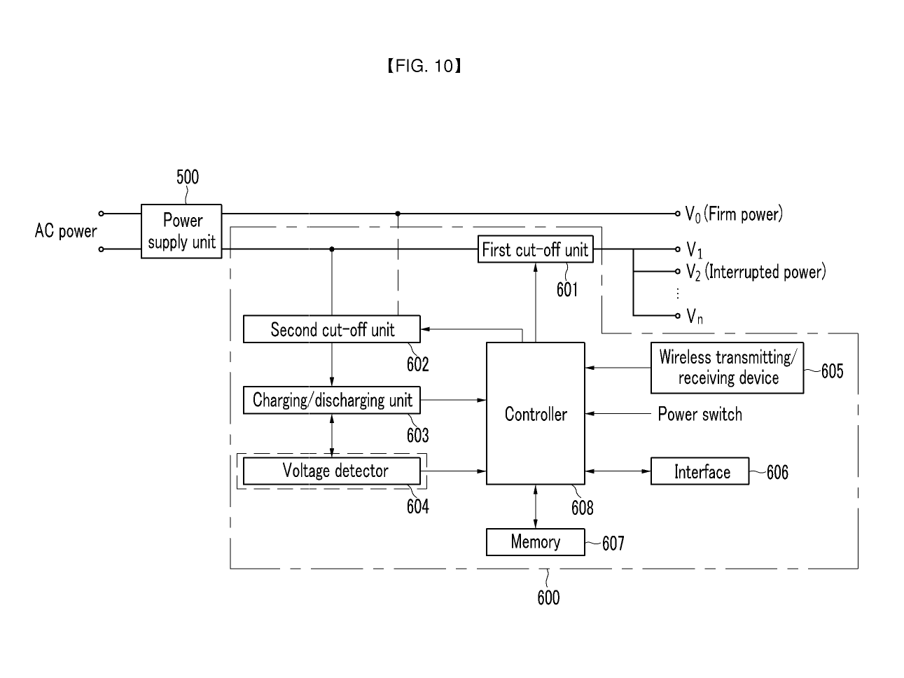

Referring to FIG. 10, the power supply according to the fifth exemplary embodiment of the present invention is formed of a power supply unit 500 and a standby power cut0off module 600.

The power supply unit 500 rectifies and decreases AC power supplied through a socket or a plug connected to a power strip extended from a socket, converts the AC power to DC power that is necessary for each function module of an electrical appliance, and outputs the AC power to at least one of multiple power lines.

The power supply unit 500 converts, for example, 200V of AC power to 3V, 5V, 10V, and 15V DC power and outputs the converted DC power.

The power supply unit 500 may be formed with one of a linear-type trans-rectifier and an AC/DC converter.

When the function module requiring consistent power supply is installed in an electrical appliance in which the power supply according to the fifth exemplary embodiment of the present invention is installed, a power line (0V) of the power supply unit 500 is directly connected to the corresponding function module to consistently supply power to the electrical appliance without regard to power on/off of the electrical appliance.

The function module requiring consistant power supply may be, for example, a hard disk or a main control unit (MCU) that is installed in an IPTV or a smart TV and requires a booting time.

The standby power cut-off module 600 includes a first cut-off unit 601, a second cut-off unit 602, a charging/discharging unit 603, a wireless transmitting/receiving unit 605, an interface 606, a memory 607, and a controller 608.

The first cut-off unit 601 is installed in an output line of the power supply unit 500, and is turned on/off according to control of the controller 608 to cut-off power supplied to a function module that does not require consistant power supply.

The first cut-off unit 601 may be applied as one of a SCR, a triac, a photo coupler, a relay, a transistor, and an FFT as a switching means.

The first cut-off unit 601 supplies power output from the power supply unit 500 to the function module according to control of the controller 608 while the electrical appliance is maintained in the power-on state, and cuts off power output from the power supply unit 500 and supplied to the function module to thereby prevent standby power consumption while the electrical appliance is maintained in the power-off state.

The second cut-off unit 602 is connected to an output line of the power supply unit 500 and turned on/off according to control of the controller 608 to control power supplied to the charging/discharging unit 603.

The second cut-off unit 603 may be applied as one of a SCR, a triac, a photo coupler, a relay, a transistor, and an FFT as a switching means.

The charging/discharging unit 603 is formed of a super capacitor including an instantaneous charging function and supplies power to each constituent element of the standby power cut-off module 600 while the standby power cut-off function is activated. The charging/discharging unit 603 is charged by power supplied through the second cut-off unit 602.

The charging/discharging unit 603 may be applied as a super capacitor having an instantaneous charging function or a battery.

The wireless transmitting/receiving unit 605 receives a power on/off control signal of an electrical appliance, transmitted from the remote controller and supplies data corresponding to the signal to the controller 608.

The wireless transmitting/receiving unit 605 may be independently installed, or may use a wireless transmitting/receiving unit installed in a front side of a housing of the electrical appliance.

The wireless transmitting/receiving unit 605 may power on/off the electrical appliance according to the power on/off control signal of the remote controller.

The wireless transmitting/receiving unit 605 may be formed with, for example, an infrared ray (IR), a Bluetooth, a zigbee, a radio frequency, or an RF4C module according to a communication method set in the remote controller.

The interface 606 is connected to a main controller of the electrical appliance to supply an interface for set data and control data.

The interface 606 may receive time-related data including a reservation function of the electrical appliance from the main controller and interface the same to the controller 608.

The interface 606 interfaces the power on signal of the electrical appliance, supplied from the controller 608 to the main controller to control the electrical appliance to be powered on according to a reservation time or a power on signal of the remote controller by the main controller of the electrical appliance.

The memory 607 stores the power on/off control signal of the remote controller, received through the wireless transmitting/receiving unit 605 in a predetermined area, and time-related data including the reservation function interfaced from the main controller of the electrical appliance through the interface 606 in a predetermined area.

The memory 607 may be formed with various types of storing media including a RAM, which is a volatile memory, or a flash memory.

The controller 608 controls power supplied to each function module connected to the output line of the power supply unit 500 according to the power on/off control signal of the remote controller, detected through the wireless transmitting/receiving unit 605 to stably supply power or prevent standby power consumption.

When the power off control signal transmitted from the remote controller is detected through the wireless transmitting/receiving unit 605 while the electrical appliance is maintained in the power on state, the controller 608 turns off the first cut-off unit 601 after a predetermined time delay to cut-off power supplied from the power supply unit 500 to the respective function modules of the electrical appliance, thereby prevent standby power consumption.

The time delay is time taken until the electrical appliance is normally powered off, and is about one to several seconds.

When the power on control signal transmitted from the remote controller is detected through the wireless transmitting/receiving unit 605 while the electrical appliance is powered off and thus power supplied to each function module is cut off, that is, while the standby power cut-off function is activated, the controller 608 turns on the first cut-off unit 601 maintained in the turn-off state to activate each function module by normally supply power output from the power supply unit 500 thereto, and supplies a power on signal to the main controller of the electrical appliance through the interface 606 to power on the electrical appliance according to control of the main controller.

The controller 608 turns on the second cut-off unit 602 during a first time set while the standby power cut-off function is activated according to power off of the electrical appliance to execute voltage charging of the charging/discharging unit 603 formed of a super capacitor having an instantenous charging function, and turns off the second cut-off unit 602 when the voltage charging of the charging/discharging unit 603 is executed for a predetermined time period and maintains the turn-off state of the second cut-off unit 602 for a predetermined second time.

The turn-on state of the second cut-off unit 602 is maintained for about 10 seconds, and the turn-off state of the second cut-off unit 602 is maintained for about three hours.

The duration of the turn-on state of the second cut-off unit 602 is determined depending on a charging characteristic of the charging/discharging unit 603 that executes the instantenous charging function.

The duration of the furn-off state of the second cut-off unit 602 is determined depending on a discharging characteristic of the charging/discharging unit 603 according to the amount of power consumption of the entire constituent elements.

The controller 608 can control the charging operation of the charging/discharging unit 603 all the time without regard to the turn-on/off state of the first cut-off unit 601.

When the time-related data including the reservation function is interfaced from the main controller of the electrical appliance through the interface 606, the controller 608 stores the interfaced data in a predetermined location of the memory 607 for execution of a reservation function such as an alarm or power-on.

The controller 608 turns on the first cut-off unit 601 when a reservation time stored in the memory 607 is detected through a counter of an internal timer to supply power to each function module, and supplies a power on signal to the main controller of the electrical appliance through the interface 606 to execute power-on according to control of the main controller of the electrical appliance.

In addition, when a signal of a power switch or a predetermined switch installed in a predetermined location of the housing of the electrical appliance is detected while the standby power cut-off control is being executed, the controller 608 turns on the first cut-off unit 601 to normally supply power to each function module of the electrical appliance, and supplies the power on signal to the main controller of the electrical appliance through the interface 606 for execution of power-on according to control of the main controller of the electrical appliance.

A standby power cut-off operation of the power supply including the above-stated functions according to the fifth exemplary embodiment of the present invention is as follows.

When a plug of the electrical appliance in which the power supply according to the fifth exemplary embodiment of the present invention is connected to a power socket, the power supply unit 500 rectifies and decreases supplied AC power, converts the AC power to DC power for each function module of the electrical appliance, and outputs the converted power through the output line.

When a function module requiring firm power supply, for example, a hard disk that requires a booting time is installed in an electrical appliance (e.g., an IP TV or a smart TV) to which the power supply according to the fifth exemplary embodiment of the present invention is installed, an output line (V0) of the power supply unit 500 is directly connected to the hard disk to control the firm power can be supplied without regard to power on/off of the electrical appliance.

An operation performed to prevent standby power consumption by cutting off power supplied to each function module according to power off control of the electrical appliance by a remote controller will now be described.

While the electrical appliance is maintained in the power-on state, the controller 608 determines whether a power off control signal transmitted from the remote controller is detected through the wireless transmitting/receiving unit 605.

In this case, when the power off control signal transmitted from the remote controller is detected by the controller 608, the controller turns off the first cut-off unit 601 after a predetermined time laps to cut off power supplied to the respective function modules of the electrical appliance to thereby prevent standby power consumption.

The time delay is time taken until the electrical appliance is normally powered off, and is about one to several seconds.

When the electrical appliance is powered off and accordingly power supplied to each function module is cut-off, that is, while the standby power cut-off function is activated, the controller 608 maintains the voltage charging amount of the charging and discharging unit 603 higher than a predetermined voltage level for stable operation of each constituent element of the standby power cut-off module 600.

For this, the controller 608 turns on the second cut-off unit 602 for a predetermined first time determined depending on a charging characteristic of the charging/discharging unit 603, for example, for 10 seconds to instantaneously charges the charging/discharging unit 603 with a voltage that is higher than a predetermined voltage level.

In addition, the controller 608 turns off the second cut-off unit 602 for a predetermined second time determined depending on a characteristic of the power consumption amount of each constituent element of the standby power cut-off module 600, for example, for three hours to supply power to each constituent element of the standby power cut-off module 600 with the voltage charged in the charging/discharging unit 603.

The turn-on/off of the second cut-off unit 602 is iteratively performed with predetermined time intervals to stably maintain the charging/discharging unit 603 with a voltage level higher than a predetermined voltage level.

Further, when power supplied to each function module of the electrical appliance is cut-off and thus the standby power cut-off function is activated, the controller 608 determines whether the power on control signal transmitted from the remote controller is determined through the wireless transmitting/receiving unit 605.

When receiving of the power on control signal transmitted from the remote controller is detected, the controller 608 turns on the first cut-off unit 601 maintained in the turn-off state to normally supply power output from the power supply unit 500 to each function module.

In addition, the controller 608 supplies the power on signal to the main controller of the electrical appliance through the interface 606 for execution of power-on according to control of the main controller of the electrical appliance.

Further, when the time-related data including a reservation function is interfaced from the main controller of the electrical appliance through the interface 606, the controller 608 stores the interfaced data in a predetermined location of the memory 607 for execution of a reservation function such as an alarm or power-on.

Thus, the controller 608 turns on the first cut-off unit 601 when a reservation time stored in the memory 607 is detected through a counter of an internal timer to supply power to each function module.

Further, the controller 608 supplies power on signal to the main controller of the electrical appliance through the interface 606 to execute power-on according to control of the main controller of the electrical appliance.

While the standby power cut-off control is being executed, the controller 608 determines whether a selection signal of a power switch or a predetermined switch installed in a predetermined location of the housing of the electrical appliance is detected.

In this case, when the selection signal of the power switch or the predetermined switch is detected, the controller 608 determines the selection signal as a power on request, and then controls each function module of the electrical appliance to be normally supplied with power by turning on the first cut-off unit 601.

In addition, the controller 608 supplies the power on signal to the main controller of the electrical appliance through the interface 606 for execution of power-on according to control of the main controller of the electrical appliance.

As described above, the power supply according to the fifth exemplary embodiment of the present invention executes the standby power cut-function and power-on control according to the power on/off signal of the remote controller, thereby providing high energy efficiency grade to the electrical appliance.

Further, the standby power cut-off function is not applied to the a function module requiring consistent power supply so that the function module may be supplied with consistent power.

In configuration of a power supply according to a sixth exemplary embodiment of the present invention, a standby power cut-off module 600 further includes a voltage detector 604 compared to the power supply of the fifth exemplary embodiment of the present invention.

Thus, a function of each consitituent element of the power supply according to the fifth exemplary embodiment of the present invention is the same as that of each constituent element of the power supply according to the fifth exemplary embodiment of the present invention, and therefore no further description will be provided.

The voltage detector 604 continuously detects the charging amount of a charging/discharging unit 603 and provides the detection data to a controller 608 so that the charging/discharging unit 603 can maintain a voltage level higher than a predetermined voltage level according to control of the controller 608.

In the case that the voltage detector 604 is further included as described, a function of the controller 608 is executed as follows.

While in the state that an electrical appliance is powered off and power supplied to each function module is cut-off so that a standby power cut-off function is being activated, the controller 608 controls on/off of a second cut-off unit 602 according to a signal of the voltage detector 604.

While the standby power cut-off function is being activated, the controller 608 turns off the second cut-off unit 602 when the charging state of the charging/discharging unit 603 detected to be higher than a predetermined charging amount (e.g., 95%) by the voltage detector 604 to thereby prevent commercial power consumption in the standby power cut-off module 600.

In addition, while the standby power cut-off function is being activated, the controller 608 turns on the second cut-off unit 602 when the charging state of the charging/discharging unit 603 is detected to be lower than the predetermined charging amount (e.g., 35%) by the voltage detector 604 to execute voltage charging of the charging/discharging unit 603.

The controller 608 turns on/off the second cut-off unit 602 with hysteresis according to the charging amount of the charging/discharging unit 603.

For example, when the charging amount of the charging/discharging unit 603 is detected to be lower than 35%, the controller 608 turns on the second cut-off unit 602 to charge the charging/discharging unit 603, and when the charging/discharging unit 603 is charged and thus the charging amount is detected to be higher than 95%, the controller 608 turns off the second cut-off unit 602.

A standby power cut-off operation of the power supply having the above-described functions according to the sixth exemplary embodiment of the present invention is executed as follows.

When a plug of the electrical appliance in which the power supply according to the sixth exemplary embodiment of the present invention is connected to a power socket, the power supply unit 500 rectifies and decreases supplied AC power, converts the AC power to DC power for each function module of the electrical appliance, and outputs the converted power through the output line.

When a function module requiring firm power supply, for example, a hard disk that requires a booting time is installed in an electrical appliance (e.g., an IP TV or a smart TV) to which the power supply according to the sixth exemplary embodiment of the present invention is installed, an output line (V0) of the power supply unit 500 is directly connected to the hard disk to control the firm power can be supplied without regard to power on/off of the electrical appliance.

An operation performed to prevent standby power consumption by cutting off power supplied to each function module according to power off control of the electrical appliance by a remote controller will now be described.

While the electrical appliance is maintained in the power-on state, the controller 608 determines whether a power off control signal transmitted from the remote controller is detected through a wireless transmitting/receiving unit 605.

In this case, when the power off control signal transmitted from the remote controller is detected by the controller 608, the controller turns off the first cut-off unit 601 after a predetermined time laps to cut off power supplied to the respective function modules of the electrical appliance to thereby prevent standby power consumption.

The time delay is time taken until the electrical appliance is normally powered off, and is about one to several seconds.

When the electrical appliance is powered off and accordingly power supplied to each function module is cut-off so that the standby power cut-off function is activated, the controller 608 detects the charging state of the charging/discharging unit 603 supplying power to the standby power cut-off module 600 through the voltage detector 604.

When the charging amount of the charging/discharging unit 603 is higher than a predetermined charging amount (e.g., 95%), the controller 608 turns off the second cut-off unit 602 to prevent commercial power consumption in the standby power cut-off module 600.

However, when the charging amount of the charging/discharging unit 603 is lower than the predetermined charging amount (e.g., 35%), the controller 608 turns on the second cut-off unit 602 to execute voltage charging of the charging/discharging unit 603.

The controller 608 iterantively turns on/off the second cut-off unit 602 with hysteresis according to the charging amount of the charging/discharging unit 603

As described, while the electrical appliance is powered-off and thus the standby power cut-off function is being activated, the controller 608 determines whether a power on control signal transmitted from the remote controller is detected through the wireless transmitting/receiving unit 605.

In this case, when receiving of the power on control signal transmitted from the remote controller is detected, the controller 608 turns on the first cut-off unit 601 maintained in the turn-off state to normally supply power output from the power supply unit 500 to each function module.

In addition, the controller 608 supplies the power on signal to the main controller of the electrical appliance through the interface 606 for execution of power-on according to control of the main controller of the electrical appliance.

Further, when the time-related data including a reservation function is interfaced from the main controller of the electrical appliance through the interface 606, the controller 608 stores the interfaced data in a predetermined location of the memory 607 for execution of a reservation function such as an alarm or power-on.

Thus, the controller 608 turns on the first cut-off unit 601 when a reservation time stored in the memory 607 is detected through a counter of an internal timer to supply power to each function module.

Further, the controller 608 supplies power on signal to the main controller of the electrical appliance through the interface 606 to execute power-on according to control of the main controller of the electrical appliance.

While the standby power cut-off control is being executed, the controller 608 determines whether a selection signal of a power switch or a predetermined switch installed in a predetermined location of the housing of the electrical appliance is detected.

In this case, when the selection signal of the power switch or the predetermined switch is detected, the controller 608 determines the selection signal as a power on request, and then controls each function module of the electrical appliance to be normally supplied with power by turning on the first cut-off unit 601.

In addition, the controller 608 supplies the power on signal to the main controller of the electrical appliance through the interface 606 for execution of power-on according to control of the main controller of the electrical appliance.

When a power failure is continued for a long period of time or the plug is disconnected from the power socket, a voltage charged in the charging/discharging unit 603 formed with a super capacitor is decreased to be lower than a predetermined voltage level as time laps.

Thus, when the charging amount of the charging/discharging unit 603 detected from the voltage detector 603 is lower than a predetermined amount (e.g., 35%), the controller 608 turns on the second cut-off unit 602 to execute voltage charging of the charging/discharging unit 603.

However, since the AC power cannot be supplied due to the power failure or plug disconnection, the voltage charging cannot be executed and the charging/discharging unit 603 is maintained with the low charging amount such that it is completely discharged.

In this case, the second cut-off unit 602 formed with a latch-type switch is continuously maintained in the switching-on state once it is turned on by control of the controller 608 until it is turned off by the controller 608.

Accordingly, when an electrical appliance to which the power supply according to the sixth exemplary embodiment of the present invention is initially power-connected after being purchased, power is recovered after a long period of power failure, or being reused after a long period of plug disconnection, a voltage is applied to the charging/discharging unit 603 through the second cut-off unit 602 and charging is executed even though the charging/discharging unit 603 is completely discharged.

That is, the charging/discharging unit 603 can be normally charged without external physical operation.

A power supply according to a seventh exemplary embodiment of the present invention is installed in an electrical appliance using a remote controller and executes standby power cut-off and power-on control according to a power on/off control signal of the remote controller.

The seventh exemplary embodiment of the present invention is applied to a power supply of an electrical appliance having a function module that does not require consistent power supply in the power off state.

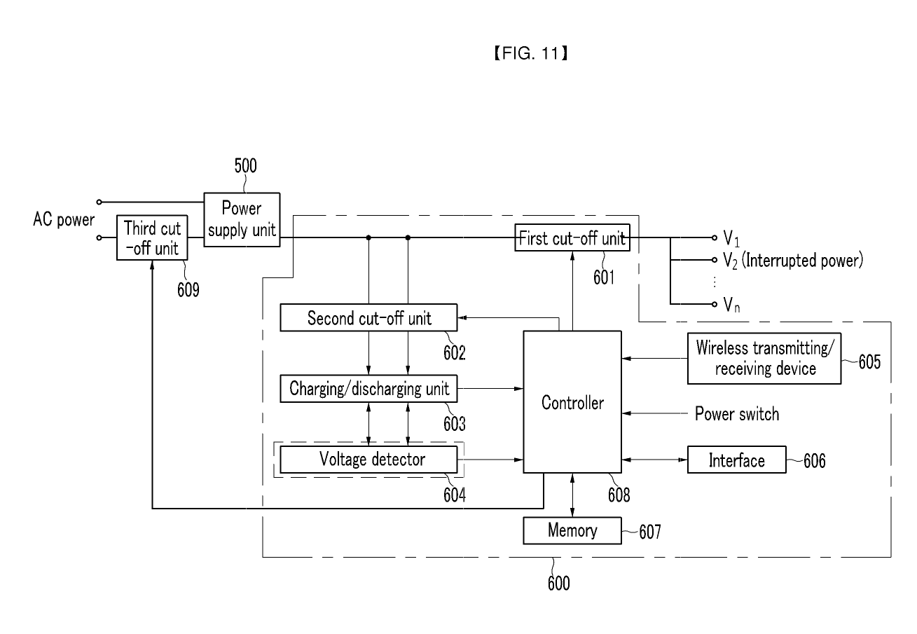

Referring to FIG. 11, the power supply according to the seventh exemplary embodiment of the present invention includes a third cut-off unit 609 formed in one of power input terminals of the power supply unit 500 of the power supply according to the fifth exemplary embodiment of the present invention.

The third cut-off unit 609 controls power supplied to the power supply unit 600 according to control of the controller 608 to maintain standby power consumption of the electrical appliance in zero state when the electrical appliance is powered off.

That is, when the electrical appliance is maintained in the power-on state, the third cut-off unit 609 is maintained in the turn-on state according to control of a controller 608 to supply AC power to the power supply unit 500, and when the electrical appliance is powered off, the third cut-off unit 609 is turned off according to control of the controller 608 to cut-off AC power supplied to the power supply unit 500.

Accordingly, the standby power consumption of the electrical appliance is maintained in zero state.

In addition, the controller 608 switches on the second and third cut-off units 602 and 609 for a predetermined first time determined depending on a charging characteristic of the charging/discharging unit 603, e.g., for 10 seconds to instantaneously charge the charging/discharging unit 603 to thereby maintain the charging/discharging unit 603 with a predetermined voltage level.

In addition, for a predetermined second time determined depending on a voltage consumption amount of each consistituent element of the standby power cut-off module 600, e.g., for three hours, the controller 608 switches off the second and third cut-off units 602 and 609 to supply power to each constituent element of the standby power cut-off module 600 with a voltage charged in the charging/discharging unit 603.

Accordingly, an output of the power supply unit 500 is completely blocked to maintain the standby power consumption in zero state.

Other operation of the power supply according to the seventh exemplary embodiment of the present invention is the same as that of the power supply according to the fifth exemplary embodiment, and therefore no further description related thereto will be provided.

As described above, the power supply according to the seventh exemplary embodiment of the present invention executes the standby power cut-off function and power-on control according to the power on/off signal of the remote controller to thereby provide a high energy efficiency grade to the electrical appliance.

A power supply according to an eight exemplary embodiment of the present invention includes a standby power cut-off module 600 further having a voltage detector 604 compared to the power supply according to the seventh exemplary embodiment of the present invention.

The voltage detector 604 continuously detects a charging amount of a charging/discharging unit 603 and provides data of the detected charging amount to a controller 608 so that the charging/discharging unit 603 can be consistently maintained with a voltage level that is higher than a predetermined voltage level according to control of the controller 608.

When the voltage detector 604 is further included, a function of the controller 608 is executed as follows.

The controller 608 turns on/off second and third cut-off units 602 and 609 according to the charging amount of the charging/discharging unit 603 provided from the voltage detector 604 to control the charging amount of the charging/discharging unit 603 to be maintained higher than the predetermined voltage level.

When the charging amount of the charging/discharging unit 603 is lower than the predetermined voltage level, the controller 608 turns on the third cut-off unit 609 to supply AC power to a power supply unit 500 while maintaining the first cut-off unit 601 in the turn-off state.

Simultaneously, the controller 608 turns on the second cut-off unit 602 to control the charging/discharging unit 603 to be charged with DC power output from the power supply unit 500, and when the charging amount of the charging/discharging unit 603 is higher than the predetermined voltage level, the controller 608 turns off the second and third cut-off units 602 and 609 to maintain the standby power consumption to be in zero state.

Other operation of the power supply according to the eight exemplary embodiment of the present invention is the same as that of the power supply according to the sixth exemplary embodiment of the present invention, and therefore no further description will be provided.

A power supply according to a ninth exemplary embodiment of the present invention is installed in an electrical appliance to which a remote controller is not applied, and executes standby power cut-off and power-on control according to a power on/off control signal of a power switch.

The electrical appliance to which a remote controller is not applied may exemplarily include a laundry, a microwave, a dish-washer, and the like, and may include other various types of electrical appliances.

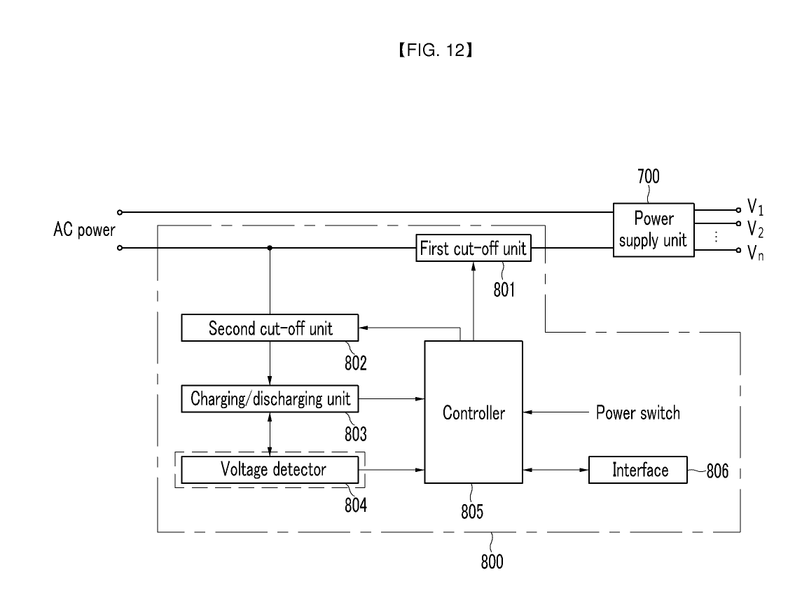

Referring to FIG. 12, a power supply according to a ninth exemplary embodiment of the present invention is formed of a power supply unit 700 and a standby power cut-off module 800.

The power supply unit 700 converts AC power supplied through a plug connected to a power socket or a multi tap extended from the power socket to DC power and outputs the converted power to at least one of a plurality of power lines V1 to Vn.

The power supply unit 700 may be formed with a linear trans-rectifier or an AC/DC converter, and it converts 220V of AC power to 3V, 5V, 10V, and 15V DC power and outputs the DC powers.

The standby power cut-off module 800 includes a first cut-off unit 801, a second cut-off unit 803, a controller 805, and an interface 806.

The first cut-off unit 801 is connected to one of AC power supply lines, and controls AC power supplied to the power supply unit 700 to be cut-off or supplied according to control of a controller 805.

The first cut-off unit 801 may be formed with any one of an SCR, a triac, a photocoupler, a relay transistor, and a FET as a switching means.

The first cut-off unit 801 supplies the AC power to the power supply unit 700 according to control of the controller 805 while the electrical appliance is maintained in the power-on state, and cuts off the AC power supplied to the power supply unit 700 while the electrical appliance is maintained in the power off state to prevent occurrence of standby power consumption.

The second cut-off unit 802 is connected to one of the AC power supply lines of the power supply unit 700, and controls power supplied to a charging/discharging unit 803 according to control of the controller 805.

The second cut-off unit 802 may be formed with any one of an SCR, a triac, a photocoupler, a relay transistor, and a FET as a switching means.

The charging/discharging unit 803 may be formed with a super capacitor including an instantaneous charging function, and is charged by power supplied through the second cut-off unit 802 and supplies power to each constituent element of the standby power cut-off module 800.

The charging/discharging unit 803 may be formed with one of a super capacitor that charging/discharging power or a battery.

The charging/discharging unit 802 directly receives AC power through the second cut-off unit 802 so that it may include a rectifying means for conversion of the AC power into DC power.

The controller 805 turns on/off the first cut-off unit 801 according to an on or off signal of a power switch, selected by a user to supply or block AC power to the power supply unit 700 to thereby prevent standby power consumption.

The predetermined schedule function may implya procedure, for example, from washing and drying in a laundry.

While the standby power cut-off function is being activated by cutting off AC power supplied from the power supply unit 700, the controller 805 switches on the second cut-off unit 802 for a predetermined first time determined depending on a charging characteristic of the charging/discharging unit 803, for example, for 10 seconds to instantaneously charge the charging/discharging unit 803 such that the charging/discharging unit 803 can be maintained with a predetermined voltage level.

In addition, the controller 805 switches off the second cut-off unit 802 for a predetermined second time determined depending on a voltage consumption amount of each constituent element of the standby power cut-off module 800, for example, for three hours to supply power to each constituent element of the standby power cut-off module 800 with the voltage charged in the charging/discharging unit 803.

Such an operation is iteratively performed with a predetermined time interval to maintain the voltage of the charging/discharging unit 803 to be consistently higher than a predetermined voltage level.

In addition, the controller 805 supplies a power on signal to the main controller of the electrical appliance through the interface 806 such that power-on can be executed according to control of the main controller.

Further, when time-related data including a reservation function is interfaced through the interface 80 from the main controller of the electrical appliance, the controller 805 stores the interfaced data in a memory area for execution of a reservation function such as power-on.

A standby power cut-off operation of the power supply including the above-described function according to the ninth exemplary embodiment of the present invention is executed as follows.

First, power supplied to the power supply unit is cut off as the power switch is powered off to prevent standby power consumption. This operation will now be described.

While the electrical appliance to which the power supply according to the ninth exemplary embodiment of the present invention is installed is being operated, the controller 805 determines whether a power off signal of the power switch according to user's selection is detected or whether termination of a scheduled function specified through the interface 806 is detected.

The specified scheduled function, for example, implies a schedule from the start of washing to drying of a laundry.

For example, the scheduled function implies washing, drying, and sterilizing of a dish-washer.

When the power off signal of the power switch is detected or termination of the specified schedule function is detected through the interface 806, the controller turns off the first cut-off unit 802 to cut off power supplied to the AC power supply unit 700 to thereby maintain the standby power consumption in zero state.

In addition, the controller 805 switches on the second cut-off unit 802 during a predetermined first time determined depending on a charging characteristic of the charging/discharging unit 803, e.g., for 10 seconds, to instantaneously charge the charging/discharging unit 803 with input of the AC power to thereby maintain the charging/discharging unit 803 with a predetermined voltage level.

Then, the controller 805 switches off the second cut-off unit 802 for a predetermined second time determined depending on the voltage consumption amount of each constituent element of the standby power cut-off module 400, e.g., for three hours to supply power to each constituent element of the standby power cut-off module 800 with the voltage charged in the charging/discharging unit 803.

In addition, while the standby power cut-off function is being activated, the controller 805 determines a power-on signal is detected from the power switch.

When the power-on signal of the power switch is detected, the controller 805 turns on the first cut-off unit 801 maintained in the turn-off state to supply AC power to the power supply unit 700.

Thus, the power supply unit 700 converts the supplied AC power to DC power and supplies operation power to each function module of the corresponding electrical appliance.

As described, the power supply according to the ninth exemplary embodiment of the present invention is applied to an electrical appliance to which a remote controller is not applied so that the standby power cut-off function can be executed and accordingly high energy efficiency grade can be provided.

A power supply according to a tenth exemplary embodiment of the present invention includes a standby power cut-off module 800 further including a voltage detector 804 compared to a configuration of the power supply according to the ninth exemplary embodiment of the present.

The voltage detector 804 continuously detects the charging amount of a charging/discharging unit 803 and provides data of the detected charging amount to a controller 805 to control the charging/discharging unit 803 to be normally maintained with a voltage that is higher than a predetermined voltage level according to control of the controller 805.

As described, when the voltage detector 804 is further included, a function of the controller 805 is performed as follows.

The controller 805 turns on/off a second cut-off unit 802 according to the charging amount of the charging/discharging unit 803 provided from the voltage detector 804 to maintain the charging amount of the charging/discharging unit 803 to be higher than the predetermined voltage level.

When the charging amount of the charging/discharging unit 803 is lower than the predetermined voltage level, the controller 805 instantaneously charges the charging/discharging unit 803 with AC power by turning on the second cut-off unit 802, and when the charging/discharging unit 803 is charged higher than a predetermined voltage level, the controller 805 turns off the second cut-off unit 802 to cut off the AC power supply to thereby maintain the standby power consumption in zero state.

A standby power cut-off operation of the power supply including the above-described function according to the tenth exemplary embodiment of the present invention is as follows.

First, power supplied to a power supply unit is cut off according to power-off of a power switch to prevent standby power consumption. This operation will now be described.

While an electrical appliance to which the power supply according to the tenth exemplary embodiment of the present invention is installed is being operated, the controller 805 determines whether a power off signal of the power switch according to user's selection is detected or whether termination of a scheduled function specified through an interface 806 is detected.

The specified scheduled function, for example, implies a schedule from the start of washing to drying of a laundry.

For example, the scheduled function implies washing, drying, and sterilizing of a dish-washer.

When the power off signal of the power switch is detected or termination of the specified schedule function is detected through the interface 806, the controller turns off the first cut-off unit 802 to cut off power supplied to the AC power supply unit 700 to prevent occurrence of standby power consumption.

As described, while the AC power supplied to the power supply unit 700 is being cut-off, that is, while the standby power cut-off function is being activated, the controller 805 detects a charging amount of the charging/discharging unit 803 through the voltage detector 804.

In this case, when the detected charging amount of the charging/discharging unit 803 is higher than a predetermined charging amount (e.g., 95%), the controller 805 turns off a second cut-off unit 802 to prevent the standby power from being wasted in the standby power cut-off module 800.

That is, when the charging amount of the charging/discharging unit 803 is maintained higher than the predetermined charging amount, the standby power cut-off module 800 is operated with a voltage of the charging/discharging unit 803.

In addition, when the detected charging amount of the charging/discharging unit 803 is lower than a predetermined charging amount (e.g., 35%), the second cut-off unit 802 is turned on to execute charging of the charging/discharging unit 803.

The second cut-off unit 802 is turned on/off with hysteresis according to the charging amount of the charging/discharging unit 803.

For example, when the charging amount of the charging/discharging unit 803 is detected to be lower than 35% by the voltage detector 804, the second cut-off unit 802 is turned on to instantaneously charge the charging/discharging unit 803 with the AC power, and when the charging amount of the charging/discharging unit 803 is charged higher than 95% according to AC power supply, the second cut-off unit 802 is turned off to control the standby power consumption of the standby power cut-off module 800 to be zero.

Further, while the standby power cut-off function is being activated, the controller 805 determines whether a power-on signal from the power switch is detected.

When the power-on signal of the power switch is detected, the controller 805 turns on the first cut-off unit 801 maintained in the turn-off state to supply the AC power to the power supply unit 700.

Thus, the power supply unit 700 converts the supplied AC power to DA power and supplies operation power to each function module of the corresponding electrical appliance.

As described, the power supply according to the tenth exemplary embodiment of the present invention is applied to an electrical appliance to which a remote controller is not applied so that the standby power cut-off function can be executed and accordingly high energy efficiency grade can be provided.

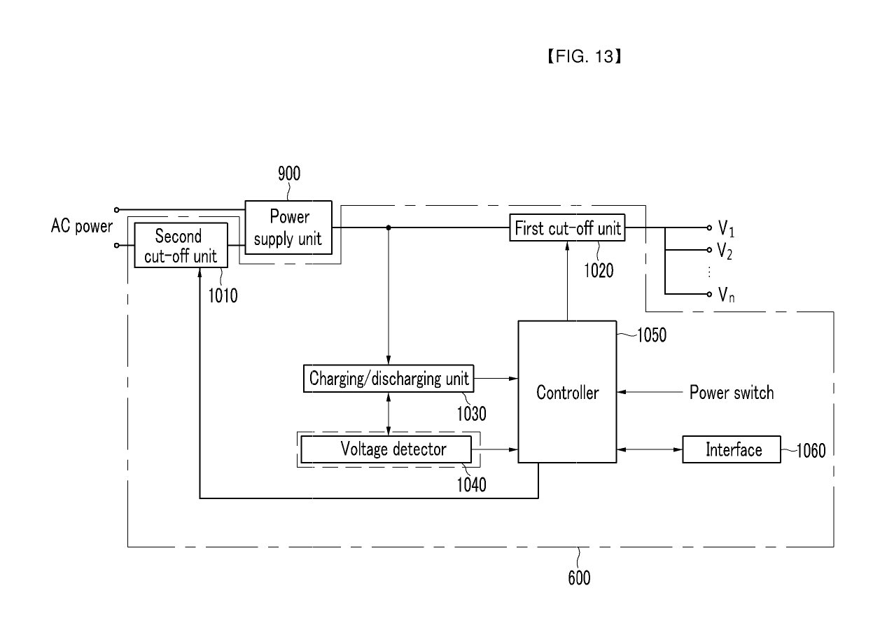

Referring to FIG. 13, a power supply according to an eleventh exemplary embodiment of the present invention is formed of a standby power cut-off module 1000 including a power supply unit 900, a second cut-off unit 1010, a first cut-off unit 1020, a charging/discharging unit 1030, a controller 1050, and an interface 1060.

The power supply unit 900 may be formed with a linear trans-rectifier, an AC/DC converter, or a SMPS module, and it converts AC power to 3V, 5V, 10V, and 15V DC power and outputs the DC powers to at least one of a plurality of power lines V1 to Vn.

The second cut-off unit 1010 is connected with one of AC power supply lines to control the AC power supplied to the power supply unit 900 according to control of the controller 1050.

While the electrical appliance is maintained in the power-on state, the second cut-off unit 1010 supplies the AC power to the power supply unit 900 according to control of the controller 1050, and when the electrical appliance is powered off, the second cut-off unit 1010 cuts off the AC power supplied to the power supply unit 900 to prevent standby power consumption in the electrical appliance.

The first cut-off unit 1020 is connected with an output line of the power supply unit 900 to control power supplied to each function module of the electrical appliance according to control of the controller 1050.

The second cut-off unit 1010 and the first cut-off unit 1020 may be applied as one of an SCR, a triac, a photocoupler, a relay transistor, and a FET as switching means.

The charging/discharging unit 1030 is connected with the output line of the power supply unit 900 and charged with DC power output therefrom so that it does not include an additional power conversion device, and supplies operation power to each constituent lement of the standby power cut-off module 1000.

The charging/discharging unit 1030 may be applied as one of a super capacitor having an instantaneous charging function or a battery.

The controller 1050 turns on/off the first and second cut-off units 1010 and 1020 according to an on/off signal of the power switch selected by a user to control the entire operation so as to prevent standby power consumption.

When termination of an operation specified according to a scheduled function is detected, the controller 1050 turns off the first cut-off unit 1020 to cut-off power supplied to each function module to thereby prevent standby power consumption.

While the standby power cut-off function is being activated, the controller 1050 turns on/off the second cut-off unit 1010 with a predetermined time interval to maintain the charging/discharging unit 1030 with a voltage higher than a predetermined voltage level.

While cutting off AC power supplied to the power supply unit 900 to activate the standby power cut-off function, the controller 1050 switches on the second cut-off unit 1010 for a predetermined first time determined depending on a charging characteristic of the charging/discharging unit 1030, e.g., 10 seconds, to maintain the charging/discharging unit 1030 formed of a super capacitor with a predetermined voltage level by instantaneously charging the same.

In addition, the controller 1050 switches off the second cut-off unit 1010 for a predetermined second time determined depending on a voltage consumption amount of each constituent element of the standby power cut-off module 1000, e.g., three hours to supply power to each constituent element of the standby power cut-off module 1000 with the voltage charged in the charging/discharging unit 1030.

In this case, the controller 1050 maintains the first cut-off unit 1020 in the turn-off state to prevent power supply to each function module, thereby prevent standby power consumption.

As described, the power supply according to the eleventh exemplary embodiment of the present invention is applied to an electrical appliance to which a remote controller is not applied so that the standby power cut-off function can be executed and accordingly high energy efficiency grade can be provided.

A power supply according to a twelfth exemplary embodiment of the present invention includes a standby power cut-off module 100 further including a voltage detector 1040 compared to a configuration of the power supply according to the ninth exemplary embodiment of the present invention.

The voltage detector 1040 continuously detects the charging amount of a charging/discharging unit 1030 and provides data of the detected charging amount to a controller 1050 to control the charging/discharging unit 1033 to be normally maintained with a voltage that is higher than a predetermined voltage level according to control of the controller 1050.

As described, when the voltage detector 1040 is further included, a function of the controller 1050 is performed as follows.

The controller 1050 turns on/off a second cut-off unit 1010 according to the charging amount of the charging/discharging unit 1030 provided from the voltage detector 1040 to maintain the charging amount of the charging/discharging unit 1030 to be higher than the predetermined voltage level.

When the charging amount of the charging/discharging unit 1030 is lower than a predetermined voltage level (e.g., 35%), the controller 1050 turns on the second cut-off unit 1010 to instantaneously charge the charging/discharging unit 1030 with DC power output from the power supply unit 900, and when the charging/discharging unit 1030 is charged to be higher than a predetermined voltage level (e.g., 95%), the controller 1050 cuts off AC power supplied to the power supply unit 900 by turning off the second cut-off unit 1010 to maintain the standby power consumption in zero state.

Other functions of the power supply is similar or equivalent to that of the power supply of the eleventh exemplary embodiment, and therefore no further description will be provided.

In addition, when a long period of power failure occurs or the plug is disconnected from the power socket, a voltage charged in the charging/discharging unit 1030 formed of a super capacitor is decreased lower than a predetermined voltage as time laps.

Thus, the controller 1050 turns on the second cut-off unit 1010 to charge the charging/discharging unit 1030 with a rectified voltage supplied through the power supply unit 900 when the charging amount of the charging/discharging unit 1030 is detected to be lower than a predetermined voltage (e.g., 35%) by the voltage detector 1040.

However, since AC power cannot be supplied due to power failure or plug disconnection, the charging/discharging unit 1030 cannot be charged, and the charging/discharging unit 1030 is completely discharged when the discharging state is continued for a long period of time.

In this case, when the second cut-off unit 1010 formed with a latch-type switch is switched on by control of the controller 1050, the second cut-off unit 1010 continuously maintains the switch-on state until switch-off control is executed.

Thus, when a power failure occurs for a long period of time, an electrical appliance to which the power supply according to the present invention is initially connected to power after being purchased, or a plug of the electrical appliance is connected for reusing after long period of disconnection, the charging/discharging unit 1030 can be supplied with a charging voltage through the first cut-off unit 1020 and the power supply unit 900 even though the charging/discharging unit 1030 is completely discharged so that the electrical appliance can be normally operated without physical operation.

The twelfth exemplary embodiment of the present invention is applied to a power supply of an electrical appliance to which a remote controller is not applied and having relatively lone standby hours and thus the standy power cut-off function can be executed so that the energy efficiency grade of the product can be improved.

In addition, the standby power cut-off module is charged using DC power output from a typical power supply applied to an electrical appliance so that the manufacturing cost of the power supply can be reduced.

As explained above, in the present invention, commercial power (main power) supplied to a target electrical appliance is normally supplied or cut off in response to a power on/off control signal of the remote control, so standby power consumption generated in the powered-off state of the electrical appliance is avoided, resulting in no power loss.

Moreover, the power of the target electrical appliance is remotely turned on upon receipt of power on control data of the remote control without a particular manipulation in a state in which the power supplied to the electrical appliance is cut off, and power on/off is controlled by employing a reservation function, thereby offering convenience of use.

Further, it is desirable and most ideal that a power strip in which the standby power cut-off device according to the present invention is composed of several sockets to minimize standby power.

The exemplary embodiments of the present invention are not only realized by the method and device, but are also realized by a program for realizing functions corresponding to the configurations of the exemplary embodiments of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

What is claimed is:

1. A standby power cut-off device, provided to a power strip, comprising:
a voltage converter for converting commercial power into DC power;
a charging/discharging unit for charging the DC power supplied from the voltage converter and supplying the same to a load;
a voltage detector for detecting a charging level of the charging/discharging unit;
a receiver for receiving power on/off control data of a remote control;
a controller for executing standby power cut-off control of a designated electrical appliance in accordance with the power on/off control data of the remote control;
a first switch that is switched on/off under the control of the controller to permit or cut off the commercial power (main power) supplied to the electrical appliance;
a transmitter for sending the power on control data of the electrical appliance under the control of the controller; and
a second switch that is switched on/off under the control of the controller to permit or cut off the commercial power (main power) supplied to the voltage converter,
all of which are configured in a power strip.

2. The standby power cut-off device of claim 1, wherein the charging/discharging unit is composed of a super condenser.

3. The standby power cut-off device of claim 1, wherein the first and second switches are any one of an SCR, a triac, a photocoupler, a relay transistor, and a FET.

4. The standby power cut-off device of claim 1, wherein the controller further comprises a memory that learns the power on/off control data of the remote control of each electrical appliance and stores the learned power on/off control data as a database.

5. The standby power cut-off device of claim 1, wherein the controller controls the on/off of the second switch in accordance with the voltage level of the charging/discharging unit to maintain the voltage of the charging/discharging unit at more than a reference voltage, and minimizes standby power consumption of the power strip.

6. The standby power cut-off device of claim 1, wherein the controller assigns an identification number to each of at least one socket configured in the power strip, and matches an electrical appliance connected to the socket with the identification number to learn and store power on/off control data of the remote control.

7. The standby power cut-off device of claim 1, wherein, upon receipt of the control data of the remote control through the receiver, the controller turns off the power of the target electrical appliance and then switches off the first switch after a predetermined time for stabilization to cut off the commercial power (main power) supplied to the target electrical appliance.

8. The standby power cut-off device of claim 1, wherein, upon receipt of the power-on control data of the remote control through the receiver in a state in which the commercial power (main power) supplied to the electrical appliance is cut off by switching off the first switch, the controller switches on the first switch to supply commercial power (main power) to the electrical appliance, and then turns on the power of the electrical appliance by sending the learned power on control data of the electrical appliance to the electrical appliance through the transmitter.

9. The standby power cut-off device of claim 1, wherein, in a state in which commercial power (main power) is supplied to the plugged-in electrical appliance by turning on the first switch, the controller controls the second switch to be turned on to supply stable power to each load of the power strip.

10. The standby power cut-off device of claim 1, wherein, if the voltage level of the charging/discharging unit provided from the voltage detector is a preset lower limit reference level, the controller turns on the second switch to execute charging, and if the voltage level of the charging/discharging unit is a preset upper limit reference level, the controller turns off the second switch to cut off overcharging and standby power consumption of the power strip.

11. The standby power cut-off device of claim 1, wherein,
in the receiving of power on/off data and transmitting of power on data, the receiver and the transmitter employ various methods, including:
a method of receiving IR communication and transmitting IR communication;
a method of receiving IR communication and transmitting RF communication;
a method of receiving RF communication and transmitting RF communication; and
a method of receiving RF communication and IR communication.

12. The standby power cut-off device of claim 1, wherein the receiver and the transmitter are configured as independent modules separate from the power strip, and the transmission and reception modules installed in a stable wireless communication environment and the power strip are connected by wires so that the transmission and reception of the power on/off control data of the remote control are executed.

13. A standby power cut-off device, provided to a power strip, comprising:
a voltage converter for converting commercial power into DC power;
a charging/discharging unit for charging the DC power supplied from the voltage converter and supplying the same as load power;
a radio receiver for receiving power on/off control data of a remote control;
a controller for executing standby power cut-off control of an electrical appliance in accordance with the received power on/off control data of the remote control;
a first switch that is switched on/off under the control of the controller to permit or cut off the commercial power (main power) supplied to the electrical appliance;
a radio transmitter for sending the power on control data of the electrical appliance under the control of the controller;
a second switch for permitting or cutting off the commercial power (main power) supplied to the voltage converter; and
a timer for controlling the on/off operation of the second switch in accordance with learned charging and discharging characteristics of the charging/discharging unit.

14. The standby power cut-off device of claim 13, wherein the controller learns and stores the charging and discharging characteristics of the charging/discharging unit with regard to the power consumption of all load elements, and controls the resetting of the timer and the start of the counter in accordance with the learned charging and discharging characteristics of the charging/discharging unit in a state in which the commercial power (main power) supplied to the electrical appliance is cut off.

15. A control method of a standby power cut-off device, provided to a power strip, the method comprising:
learning power on/off control data of a remote control of each electrical appliance and storing the same in a database;
determining whether the control data of the remote control is received in a standby mode;
upon receipt of the control data of the remote control, determining the format of the control data by comparing the received control data of the remote control with the learned data;
if the format of the control data of the remote control is the power off control data of the electrical appliance, waiting for a predetermined time and then cutting off the commercial power (main power) supplied to the target electrical appliance; and
if the format of the control data of the remote control is the power on control data, normally supplying commercial power (main power) to the target electrical appliance, and sending the learned power on control data to turn on the power of the electrical appliance.

16. The method of claim 15, wherein the learned data stored in the database is obtained by matching an identification number of each socket configured in a power strip to the electrical appliance connected to the socket.

17. The method of claim 15, further comprising, when the cut-off of the commercial power (main power) supplied to the electrical appliance is executed, controlling the commercial power (main power) supplied to the power strip to be cut off.

18. A standby power cut-off device, provided to a power strip, comprising:
a voltage converter for converting commercial power into DC power;
a charging/discharging unit for charging the DC power and supplying the same as load power;
a voltage detector for detecting a charging level of the charging/discharging unit;
a receiver for receiving a signal sent from a remote control;
a controller that learns and stores power on/off control data sent from the remote control, stores reservation information for controlling the power on/off of an electrical appliance, and sends the learned control data at a designated reservation time to execute a designated reservation function;
a first switch for interrupting the commercial power (main power) supplied to the electrical appliance under the control of the controller;
a transmitter for sending reservation function execution data under the control of the controller;
a second switch for interrupting the commercial power (main power) supplied to the voltage converter under the control of the controller; and
a display for displaying reservation setting mode entry, a set reservation time, and current time information.

19. The standby power cut-off device of claim 18, wherein the controller comprises:
a memory for storing the learned power on/off control data of the electrical appliance and the reservation information of the electrical appliance as a database; and
a timer for counting a time to execute the reservation function.

20. The standby power cut-off device of claim 18, wherein,
if the reservation information involves the power on control of the electrical appliance, the controller switches on the first switch at a reservation time to put the electrical appliance into a standby state, and
sends the power on control data learned through the transmitter by wireless communication to turn on the power of the electrical appliance.

21. The standby power cut-off device of claim 18, wherein,
if the reservation information involves the power on control of the electrical appliance, the controller sends the power off control data learned through the transmitter by wireless communication at a reservation time to turn off the power of the electrical appliance, and
waits for a predetermined time for stabilization of the electrical appliance and then turns off the first switch to cut off the commercial power (main power) supplied to the electrical appliance.

22. A standby power cut-off device of claim 18, provided to a power supply of an electrical appliance, comprising:
a voltage converter for converting commercial power into DC power;
a charging/discharging unit for charging the DC power and supplying the same as load power;
a voltage detector for detecting a charging level of the charging/discharging unit;
a receiver for receiving a signal sent from a remote control;
a controller that learns and stores power on/off control data sent from the remote control, stores reservation data for controlling the power on/off of an electrical appliance, and sends the learned control data at a designated reservation time to execute a designated reservation function;
a first switch for interrupting the commercial power (main power) supplied to the electrical appliance under the control of the controller;
a transmitter for sending reservation function execution data under the control of the controller;
a second switch for interrupting the commercial power (main power) supplied to the voltage converter under the control of the controller; and
a display for displaying reservation setting mode entry, a set reservation time, and current time data.
a third switch formed of a power switch or an electrical appliance or a predetermined switch and activating the controller in a standby power cut-off state; and
an interface connected to a main controller of the electrical appliance to interface with time information related to the set reservation function.

23. The standby power cut-off device of claim 18, wherein,
while standby power is in the cut-off state by turning off the first switch, the controller turns on the first switch to supply main power to the power supply and executes the set reservation function when a reservation time stored in a memory unit is detected.

24. A control method of a standby power cut-off device, the method comprising:
learning power on/off control data of a remote control of each electrical appliance and storing the same in a database;
when the remote control sends a request for setting a reservation function, entering a reservation setting mode and give an instruction in a predetermined format through a display;
recognizing an electrical appliance designated by the remote control and reservation information (power on/off time) and storing the same in a database;
starting the counter of a timer and comparing the current time with the reservation information stored in the database; and
if the current time reaches a time designated in the reservation information, identifying the designated electrical appliance and the reservation function to execute the reservation function.

25. The method of claim 24, wherein, upon entering the reservation setting mode and recognizing the designated electrical appliance, the previous reservation information is initialized.

26. The method of claim 24, wherein, when the power of the electrical appliance is turned on during execution of the reservation function, commercial power is supplied to the target electrical appliance, the power supply to which is cut off, to put the electrical appliance in a standby mode, and then the learned power on control data is wirelessly sent to execute power on control.

27. The standby power cut-off device of claim 24, wherein,
when the power of the electrical appliance is turned off during execution of the reservation function, the learned power off control data is wirelessly sent to the target electrical appliance to execute power off control, and
the commercial power supplied to the target electrical appliance is cut off after the passage of a set time.

28. A power supply comprising:
a power supply unit rectifying and decreasing AC power and outputting the rectified and decreased AC power as DC power; and
a standby power cut-off module disposed in an output line of the power supply unit, cutting off power supplied to a function module when a power-off signal of a remote controller is detected, and supplying the power to the function module and simultaneously executing power-on control when a power-on signal of the remote controller is detected.

29. The power supply of claim 28, wherein the standby power cut-off module is interfaced with a main controller of an electrical appliance and executes a reservation function with interfaced reservation data set in the main controller of the electrical appliance in the standby power cut-off state.

30. The power supply of claim 28, wherein the power supply unit and a function module requiring firm power are connected with a power line to supply firm power without regard to operation of the standby power cut-off module.

31. The power supply of claim 28, wherein the standby power cut-off module comprise:
a first cut-off unit disposed in the output line of the power supply unit and controlling power supplied to the function module according to control of a controller;
a second cut-off unit disposed in the output line of the power supply unit and controlling power supplied to a charging/discharging unit according to control of the controller;
a charging/discharging unit charged by power supplied through the second cut-off unit and supplying power to constituent elements of the standby power cut-off module;
a wireless transmitting/receiving unit receiving a power on/off signal of an electrical appliance, transmitted from a remote controller and providing the received signal to the controller;
an interface connected to the main controller of the electrical appliance and executing data interface;
a memory storing data related to a reservation function time interfaced from the main controller of the electrical appliance; and
a controller executing power control supplied to the function module from the power supply unit and power-on control according to a power on/off signal of a remote controller, exechting instantaneous charging of a charging/discharging unit by turning on a second cut-off unit for a predetermined first time, and supplying power to the standby power cut-off module with a charging voltage of the charging/discharging unit by turning off the second cut-off unit for a predetermined second time.

32. The power supply of claim 31, wherein, when a power-off signal of the remote controller is detected while the electrical appliance is in the power-on state, the controller turns off the first cut-off unit after a predetermined time laps to cut off power supplied to each function module in the electrical appliance.

33. The power supply of claim 31, wherein, while the standby power cut-off function is being activate, the controller turns on the first cut-off unit to supply power output from the power supply unit to each function module when a power-on signal of the remote controller is detected and executes power-on of the electrical appliance by providing the power-on signal to a main controller of the electrical appliance through the interface.

34. The power supply of claim 31, wherein the controller stores reservation function time data interfaced from a main controller of the electrical appliance, and, when the reservation time is detected through a counter of an internal timer, the controller turns on the first cut-off unit to supply power to a function module of the electrical appliance and then execute power-on of the electrical appliance by providing the power-on signal to the main controller of the electrical appliance through the interface.

35. The power supply of claim 31, wherein, while the standboy power cut-off function is being activated, the controller turns on the first cut-off unit to supply power to the function module when a power-on request of a power switch installed in a housing of the electrical appliance or a predetermined switch is detected.

36. The power supply of claim 31, further comprising a voltage detector detecting a charging amount of the charging/discharging unit and providing the detected charging amount,
wherein the controller turns on/off the second cut-off unit with hysteresis according to the charging state of the charging/discharging unit provided from the voltage detector to maintain the charging amount of the charging/discharging unit to be higher than a predetermined voltage level while the standby power cut-off function of the electrical appliance is being activated.

37. The power supply of claim 31, wherein the predetermined first time is a charging time determined depending on a charging characteristic of the charging/discharging unit having the instantaneous charging function, and the predetermined second time is a discharging time of the charging/discharging unit determined depending on a discharging characteristic of the charging/discharging unit according to a power consumption amount of the entire constituent elements of the standby power cut-off module.

38. A power supply comprising:
a power supply unit converting AC power to DC power and outputting the DC power;
a first cut-off unit disposed in an output line of the power supply unit and controlling power supplied to a function module;
a second cut-off unit disposed in the output line of the power supply unit and controlling power supplied to a charging/discharging unit;
a charging/discharging unit charged by power supplied through the second cut-off unit and supplying power to constituent elements of a standby power cut-off module;
a wireless transmitting/receiving unit transmitting a power-on/off signal transmitted from a remote controller;
an interface executing data interface with a main controller of an electrical appliance;
a memory storing reservation function time data interfaced from the main controller of the electrical appliance; and
a controller turning off power supplied to the function module to activate a standby power cut-off function when a power-off signal of the remote controller is detected while the electrical appliance is in the power-on state, turning on the first cut-off unit to supply power to the function module when a power-on signal of the remote controller is detected while the standby power cut-off function is being activated, and executing power-on of the electrical appliance by providing the power-on signal to the main controller of the electrical appliance through the interface.

39. The power supply of claim 38, wherein, when reservation data is detected according to a timer counter while the standby power cut-off function is being activated, the controller turns on the first cut-off unit to supply power to the function module and executes power-on by interfacing the power-on signal to the main controller of the electrical appliance.

40. The power supply of claim 38, wherein, when a power-on request from a power switch or a predetermined switch is detected while the standby power cut-off function is being executed, the controller turns on the first cut-off unit to supply power to the function module and interfaces the power-on signal to the main controller of the electrical appliance.

41. The power supply of claim 38, further comprising a third cut-off unit disposed in one of power supply lines of the power supply unit,
wherein the third cut-off unit controls AC power supplied to the power supply unit according to control of the controller.

42. The power supply of claim 38, wherein the controller instantaneously charges the charging/discharging unit by turning on the second cut-off unit for a predetermined first time determined depending on a charging characteristic of the charging/discharging unit, and turns off the second cut-off unit for a predetermined second time determined depending on a discharging characteristic of the charging/discharging unit according to a power consumption amount of the entire constituent lements of the standby power cut-off module.

43. The power supply of claim 38, further comprising a voltage detector detecting a charging state of the charging/discharging unit,
wherein the controller instantaneously charges the charging/discharging unit by turning on the second cut-off unit when the charging amount of the charging/discharging unit provided from the voltage detector is lower than a predetermined first voltage, terminates a charging operation by turning off the second cut-off unit when the charging amount of the charging/discharging unit is detected to be higher than a predetermined second voltage, and controls turn-on/turn-off of the second cut-off unit with hysteresis according to the charging amount of the charging/discharging unit.

44. A power supply comprising:
a power supply unit converting AC power to DC power and outputting the DC power;
a first cut-off unit disposed in a power supply line of the power supply unit and controlling AC power supplied to the power supply unit;
a controller controlling AC power supplied to the power supply unit by turning off the first cut-off unit when a power-off signal of a power switch is detected and supplying AC power to the power supply unit by turning on the first cut-off unit when a power-on signal of the power switch is detected;
a charging/discharging unit supplying power to the controller while a standby power cut-off function is being activated;
a second cut-off unit controlling AC power to the charging/discharging unit according to control of the controller;
and an interface connected with a main controller of an electrical appliance and interfacing reservation related data and operation data.

45. The power supply of claim 44, wherein, when a scheduled function set tin the electrical appliance is detected, the controller turns off the first cut-off unit to control AC power supplied to the power supply unit to activate the standby power cut-off function.

46. The power supply of claim 44, wherein, while the standby power cut-off function is being activated, the controller charges the charging/discharging unit by turning on the second cut-off unit for a predetermined first time and turns off the second cut-off unit for a predetermined second time to normally maintain the charging/discharging unit with a voltage higher than a predetermined voltage level.

47. The power supply of claim 44, wherein, when reservation information interfaced from the main controller of the electrical appliance and then stored, the controller turns on the first cut-off unit at a predetermined reservation time to supply AC power to the power supply unit and provides a trigger signal to the main controller through the interface to thereby execute a predetermined reservation function.

48. The power supply of claim 44, wherein the charging/discharging unit includes a rectifying means to convert AC power to DC power, and is formed of a super capacitor having an instantaneous charging function.

49. The power supply of claim 44, further comprising a voltage detector providing charging amount data of the charging/discharging unit while the standby power cut-off function is being activated,
wherein the controller monitors data provided from the voltage detector, and instantaneously charges the charging/discharging unit with AC power by turning on the second cut-off unit when the charging amount of the charging/discharging unit is lower than a predetermined first voltage, terminates charging operation by turning off the second cut-off unit when the charging amount of the charging/discharging unit is higher than a predetermined second voltage, and controls turn-on/turn-off of the second cut-off unit with hysteresis according to the charging amount of the charging/discharging unit.

50. A power supply comprising:
a power supply unit converting AC power to DC power and outputting the DC power;
a second cut-off unit controlling AC power supplied to the power supply unit;
a first cut-off unit controlling power supplied to a function module from the power supply unit;
a charging/discharging unit charged by output power of the power supply unit and supplying power to constituent elements of a standby power cut-off module;
a voltage detector detecting a charging amount of the charging/discharging unit and providing the detected charging amount;
a controller cutting off power supplied to the power supply unit and function modules by turning off the first and second cut-off units when a power-off signal of a power switch is detected, and controlling the power supply unit and the function modules to be executed by turning on the first and second cut-off units when a power-on signal is detected; and
an interface connected with a main controller of an electrical appliance and providing an interface of reservation related-data and operation data.

51. The power supply of claim 50, wherein the controller normally maintains the charging/discharging unit to be higher a predetermined voltage level with output power of the power supply unit by turning on/off the second cut-off unit while the first cut-off unit is being turned off according to the charging amount of the charging/discharging unit, detected through the voltage detector.

52. The power supply of claim 50, wherein the controller supplies power to each function module by turning on the first and second cut-off units at a reservation time interfaced from the main controller of the electrical appliance and then stored, and executes a predetermined reservation function by providing a trigger signal to the main controller of the electrical appliance through the interface.

53. The power supply of claim 50, wherein the controller turns on the second cut-off unit when the charging/discharging unit is discharged to be lower than a predetermined voltage level when a power failure occurs or a plug is disconnected, and the second cut-off unit formed with a latch-type switch continuously maintains the switch-on state until switch-off control of the controller is executed to execute charging operation of the charging/discharging unit without physical operation when a power failure occurs for a long period of time, the electrical appliance is initially connected to power after being purchased, or a plug of the electrical appliance is connected for reusing after long period of disconnection.
